(19) United States
(12) Patent Application Publication
(10) Pub. No.: US 2025/0219915 A1
(43) Pub. Date: Jul. 3, 2025

(54) Distribution of RAN-Visible QoE Measurements

(71) Applicant: Telefonaktiebolaget LM Ericsson (publ), Stockholm (SE)

(72) Inventors: Luca Lunardi, Genova (IT); Filip Barac, Huddinge (SE); Johan Rune, Lidingö (SE)

(21) Appl. No.: 18/850,141

(22) PCT Filed: Apr. 24, 2023
(86) PCT No.: PCT/SE2023/050372

§ 371 Date: Sep. 24, 2024

Related U.S. Application Data
(60) Provisional application No. 63/344,444, filed on May 20, 2022.

(51) Int. Cl. H04L 41/5067; H04L 1/00; H04W 24/10; H04W 76/20

(52) U.S. Cl. CPC H04L 41/5067; H04L 1/0003; H04W 24/10; H04W 76/20

(57) ABSTRACT

Embodiments include methods for distributing quality-of-experience (QoE) measurements performed by user equipment (UEs) in a radio access network (RAN). These methods are performed by a first network node or function (NNF) of the RAN and include receiving one or more fourth messages from a second NNF of the RAN. Each fourth message includes one or more RAN-visible QoE (RVQoE) measurement reports, each RVQoE measurement report includes one or more RVQoE metrics or values, and each RVQoE metric or value is based on QoE measurements performed by a particular UE that is associated with the first NNF. Such methods also include sending to the second NNF a first message including a request to stop sending RVQoE measurement reports to the first NNF. Other embodiments include complementary methods for the second NNF, as well as NNFs configured to perform such methods.

### TECHNICAL FIELD

The present disclosure relates generally to wireless networks, and more specifically to techniques for distributing application-layer (e.g., quality-of-experience) measurements made by user equipment (UEs) to networks nodes (or functions) within a radio access network (RAN).

### BACKGROUND

Currently the fifth generation (5G) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates an exemplary high-level view of the 5G network architecture, consisting of a Next Generation RAN (NG-RAN) 199 and a 5G Core (5GC) 198. NG-RAN 199 can include a set of gNodeB's (gNBs) connected to the 5GC via one or more NG interfaces, such as gNBs 100, 150 connected via interfaces 102, 152, respectively. In addition, the gNBs can be connected to each other via one or more Xn interfaces, such as Xn interface 140 between gNBs 100 and 150. With respect to the NR interface to UEs, each of the gNBs can support frequency division duplexing (FDD), time division duplexing (TDD), or a combination thereof.

NG-RAN 199 is layered into a Radio Network Layer (RNL) and a Transport Network Layer (TNL). The NG-RAN architecture, i.e., the NG-RAN logical nodes and interfaces between them, is defined as part of RNL. For each NG-RAN interface (NG, Xn, F1) the related TNL protocol and the functionality are specified. TNL provides services for user plane transport and signaling transport.

The NG RAN logical nodes shown in FIG. 1 include a central (or centralized) unit (CU or gNB-CU) and one or more distributed (or decentralized) units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUS and DUs can include various circuitry needed to perform their respective functions, including processing circuitry, transceiver circuitry (e.g., for communication), and power supply circuitry.

A gNB-CU connects to gNB-DUs over respective F1 logical interfaces, such as interfaces 122 and 132 shown in FIG. 1. The gNB-CU and connected gNB-DUs are only visible to other gNBs and the 5GC as a gNB. In other words, the F1 interface is not visible beyond gNB-CU.

Centralized control plane protocols (e.g., PDCP-C and RRC) can be hosted in a different CU than centralized user plane protocols (e.g., PDCP-U). For example, a gNB-CU can be divided logically into a CU-CP function (including RRC and PDCP for signaling radio bearers) and CU-UP function (including PDCP for UP). A single CU-CP can be associated with multiple CU-UPs in a gNB. The CU-CP and CU-UP communicate with each other using the E1-AP protocol over the E1 interface, as specified in 3GPP TS 38.463 (v15.4.0). Furthermore, the F1 interface between CU and DU (see FIG. 1) is functionally split into F1-C between DU and CU-CP and F1-U between DU and CU-UP. Three deployment scenarios for the split gNB architecture shown in FIG. 1 are CU-CP and CU-UP centralized, CU-CP distributed/CU-UP centralized, and CU-CP centralized/CU-UP distributed.

FIG. 2 shows another high-level view of an exemplary 5G network architecture, including a NG-RAN 299 and 5GC 298. As shown in the figure, NG-RAN 299 can include gNBs (e.g., 210a,b) and ng-eNBs (e.g., 220a,b) that are interconnected with each other via respective Xn interfaces. The gNBs and ng-eNBs are also connected via the NG interfaces to the 5GC, more specifically to access and mobility management functions (AMFs, e.g., 230a,b) via respective NG-C interfaces and to user plane functions (UPFs, e.g., 240a,b) via respective NG-U interfaces. Moreover, the AMFs can communicate with one or more policy control functions (PCFs, e.g., 250a,b) and network exposure functions (NEFs, e.g., 260a,b).

Each of the gNBs can support the NR radio interface including frequency division duplexing (FDD), time division duplexing (TDD), or a combination thereof. Each of ng-eNBs can support the fourth generation (4G) Long-Term Evolution (LTE) radio interface. Unlike conventional LTE eNBs, however, ng-eNBs connect to the 5GC via the NG interface. Each of the gNBs and ng-eNBs can serve a geographic coverage area including one or more cells (e.g., 211a-b and 221a-b). Depending on the cell in which it is located, a UE (205) can communicate with the gNB or ng-eNB serving that cell via the NR or LTE radio interface, respectively. Although FIG. 2 shows gNBs and ng-eNBs separately, it is also possible that a single RAN node provides both types of functionality.

Quality of Experience (QoE) measurements were specified for UEs operating in earlier-generation LTE and UMTS networks and are being specified in 3GPP for UEs operating in NR networks. Measurements in all of these networks operate according to similar high-level principles, with the purpose of measuring the end-user experience for certain applications over the network. For example, QoE measurements for streaming services and for MTSI (Mobility Telephony Service for IMS) are supported in LTE and NR networks.

Radio resource control (RRC) signaling is used to configure application-layer QoE measurements in UEs and to collect QoE measurement result files from configured UEs. In particular, an application-layer measurement configuration from a core network (e.g., EPC, 5GC) or a network operations/administration/maintenance (OAM) function is encapsulated in a transparent container and sent to a UE's serving RAN node (e.g., eNB, gNB), which forwards it to the UE access stratum (AS) in an RRC message. Application-layer measurements made by the UE are encapsulated in a transparent container that is sent by the UE AS to the serving RAN node in an RRC message. The serving RAN node then forwards the container to a Trace Collector Entity (TCE) or a Measurement Collection Entity (MCE) associated with the CN.

In addition to conventional or legacy QoE metrics, 3GPP has agreed to support so-called “RAN-visible” (or RV, for short) QoE metrics and QoE values. In particular, RVQoE metrics are a subset of legacy QoE metrics collected from UE and RVQoE values are derived from legacy QoE metrics through a model and/or function. Both are RAN-visible because they can be useful (in some way) to the RAN (e.g., NG-RAN).

### SUMMARY

In the split-node architecture shown in FIG. 1, an RVQoE measurement report from a UE is received by a gNB-CU, specifically a CU-CP that hosts the RRC layer. The CU-CP can send the received RVQoE measurements to another unit or function of the gNB, e.g., a gNB-DU. Likewise, the CU-CP can send the received RVQOE measurements to a unit or function of a different gNB, e.g., a CU-CP of a second gNB that is engaged in a mobility operation or multi-connectivity with the UE.

RVQOE measurement results are transferred within a gNB using UE-associated F1AP signaling and are further divided by application session on which the UE performs the RVQoE measurements. In some cases, a UE can be configured for collecting RVQoE measurements for many different applications. Likewise, in some cases, the number of RVQoE measurements collected by the UE can be large. In such cases, the flow of RVQOE measurements within a gNB or between gNBs can become quite large and the recipient(s) may receive measurements that are not needed. However, there currently is no way to control the flow of this information.

An object of embodiments of the present disclosure is to improve handling of RVQoE measurements in a wireless network, such as by providing, enabling, and/or facilitating solutions to exemplary problems summarized above and described in more detail below.

Embodiments include methods (e.g., procedures) for distributing quality-of-experience (QoE) measurements performed by user equipment (UEs) in a radio access network (RAN). These exemplary methods can be performed by a first network node or function (NNF).

These exemplary methods can include receiving one or more fourth messages from a second NNF of the RAN. Each fourth message includes one or more RVQoE measurement reports and each RVQoE measurement report includes one or more RVQoE metrics or values, with each RVQOE metric or value based on QoE measurements performed by a particular UE that is associated with the first NNF. These exemplary methods can also include subsequently sending to the second NNF a first message including a request to stop sending RVQoE measurement reports to the first NNF.

In some embodiments, the first NNF is a gNB-DU, the second NNF is a gNB-CU or a part thereof, and the first message is sent via an F1AP interface between the first and second NNFs. In other embodiments, the first NNF is a first RAN node, the second NNF is a second RAN node, and the first message is sent via an XnAP interface between the first and second NNFs.

In some embodiments, these exemplary methods can also include, based on the one or more fourth messages, performing one or more of the following for one or more the UEs that performed QoE measurements associated with the RVQoE measurement reports: scheduling data transmission and/or reception, and selection of a modulation and coding scheme for data transmission and/or reception.

In some embodiments, these exemplary methods can also include sending, to the second NNF, a further first message including a request to start sending RVQoE measurement reports to the first NNF. The one or more fourth messages are received in response to the further first message. In some of these embodiments, the further first message indicates one or more of the following:
one-shot or periodic reporting;
if periodic reporting, a reporting period;
if one-shot, a time interval to which a report pertains or which should be excluded from a report;
a total number or amount of RVQoE measurements;
a number of RVQoE measurements per fourth message;
one or more UE-related triggering events or conditions;
one or more RVQoE-related triggering events or conditions;
one or more RRC- or radio-related triggering events or conditions:
one or more UE application layer triggering events or conditions
one or more NNF resource-related triggering events or conditions

In some of these embodiments, the first message and the further first message include same identifiers of one or more of the following: UE, UE group, QoE reference, trace recording session, and application layer measurement configuration. In some of these embodiments, the further first message indicates RVQoE measurements from all UEs that are configured for RVQoE measurements and associated with or served by one of the following: the first NNF, or the second NNF. In some of these embodiments, the further first message indicates RVQoE measurements associated with one or more of the following: network slice, cell, beam, data radio bearer, communication direction between a UE and an NNF, communication path through the RAN, protocol type, protocol addresses and/or port numbers, and a reporting periodicity.

In other embodiments, these exemplary methods can also include receiving from the second NNF a second message including an offer to send RVQoE measurement reports to the first NNF, and sending to the second NNF a ninth message including an indication of whether the first NNF accepts or rejects the offer. Moreover, the one or more fourth messages are received in response to the ninth message indicating that the first NNF accepts the offer.

In some embodiments, these exemplary methods can also include receiving from the second NNF a fifth message including assistance information for RVQoE measurement reports provided by or available from the second NNF. In some of these embodiments, the assistance information includes identifiers of one or more of the following associated with RVQoE measurement reports received in the one or more fourth messages: UE, UE group, QoE reference, trace recording session, application session PDU session, application layer measurement configuration, network slice, cell, beam, data radio bearer, communication direction, protocol type, and protocol addresses and/or port numbers.

In some of these embodiments, the fifth message is received with one of the fourth messages in a single message.

Other embodiments include additional methods (e.g., procedures) for distributing QoE measurements performed by UEs in a RAN. These exemplary methods can be performed a second NNF and are generally complementary to the first NNF methods summarized above.

These exemplary methods can include sending one or more fourth messages to a first NNF of the RAN. Each fourth message includes one or more RVQoE measurement reports, and each RVQOE measurement report includes one or more RVQoE metrics or values, with each RVQoE metric or value based on QoE measurements performed by a particular UE that is associated with the first NNF. These exemplary methods can also include subsequently receiving from the first NNF a first message including a request to stop sending RVQoE measurement reports to the first NNF.

In some embodiments, the first NNF is a gNB-DU, the second NNF is a gNB-CU or a part thereof, and the first message is sent via an F1AP interface between the first and second NNFs. In other embodiments, the first NNF is a first RAN node, the second NNF is a second RAN node, and the first message is sent via an XnAP interface between the first and second NNFs.

In some embodiments, these exemplary methods can also include, based on the first message, refraining from sending the first NNF further fourth messages including RVQoE measurement reports.

In some embodiments, these exemplary methods can also include receiving from the first NNF a further first message including a request to start sending RVQoE measurement reports to the first NNF. The one or more fourth messages are sent in response to the further first message. In various embodiments, the further first message can have any of the same content summarized above for first NNF embodiments.

In some embodiments, these exemplary methods can also include sending to the first NNF a second message including an offer to send RVQoE measurement reports to the first NNF, and receiving from the first NNF a ninth message including an indication of whether the first NNF accepts or rejects the offer. In such case, the one or more fourth messages are sent in response to the ninth message indicating that the first NNF accepts the offer.

In some embodiments, these exemplary methods can also include sending to the first NNF a fifth message including assistance information for RVQoE measurement reports provided by or available from the second NNF. In various embodiments, the assistance information can include any of the same content summarized above in relation to first NNF embodiments. In some embodiments, the fifth message is sent with one of the fourth messages in a single message.

Other embodiments include NNFs (e.g., base stations, gNBs, ng-eNBs, gNB-DUs, gNB-CUs, gNB-CU-CPs, etc.) configured to perform operations corresponding to any of the exemplary methods described herein. Other embodiments include non-transitory, computer-readable media storing program instructions that, when executed by processing circuitry, configure such NNFs to perform operations corresponding to any of the exemplary methods described herein.

These and other embodiments described herein provide flexible and efficient techniques for coordination between first and second NNFs in a RAN, so that RVQoE measurements (e.g., RVQoE metrics and/or RVQoE values) can be distributed or transferred in a controlled manner from the second NNF to the first NNF. For example, RVQoE measurements can be requested by the first NNF or offered by the second NNF. In this manner, embodiments avoid excess signaling of unwanted and/or unusable RVQOE measurements. Moreover, distribution of RVQOE measurements facilitate RAN operations such as QoE-aware traffic steering, scheduling and link adaptation, mobility-related decisions, mobility decision evaluation, and inputs to AI/ML algorithms used for network optimization and/or fault prediction. By distributing RVQoE measurements that facilitate such operations, embodiments can lead to improved RAN performance as experienced by applications and end users.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows an exemplary configuration of NR user plane (UP) and control plane (CP) protocol stacks.

FIGS. 4A-C illustrate various aspects of QoE measurement configuration for a UE in an LTE network.

FIGS. 5A-C illustrate various aspects of QoE measurement collection for a UE in an LTE network.

FIG. 6 shows a signaling diagram of an exemplary QoE Information Transfer procedure.

FIGS. 7-9 show diagrams of signaling between a first network node or function (NNF), a second NNF, a third NNF, and a UE, according to various embodiments of the present disclosure.

FIG. 10 shows a signaling diagram for certain embodiments where the first NNF is a gNB-DU and the second NNF is a gNB-CU-CP.

FIG. 11 shows a diagram of signaling between a first NNF, a second NNF, and a third NNF, according to various embodiments of the present disclosure.

FIG. 12 shows a diagram of signaling between a first NNF, a second NNF, and a fourth NNF, according to various embodiments of the present disclosure.

FIG. 13 shows a flow diagram of an exemplary method (e.g., procedure) for a first NNF of a RAN (e.g., NG-RAN), according to various embodiments of the present disclosure.

FIG. 14 shows a flow diagram of an exemplary method (e.g., procedure) for a second NNF of a RAN (e.g., NG-RAN), according to various embodiments of the present disclosure.

FIG. 15 shows a flow diagram of an exemplary method (e.g., procedure) for a fourth NNF of a RAN (e.g., NG-RAN), according to various embodiments of the present disclosure.

FIG. 16 shows a communication system according to various embodiments of the present disclosure.

FIG. 17 shows a UE according to various embodiments of the present disclosure.

FIG. 18 shows a network node according to various embodiments of the present disclosure.

FIG. 19 shows a host computing system according to various embodiments of the present disclosure.

FIG. 20 is a block diagram of a virtualization environment in which functions implemented by some embodiments of the present disclosure may be virtualized.

FIG. 21 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the enclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

5G/NR technology shares many similarities with LTE. For example, NR uses CP-OFDM (Cyclic Prefix Orthogonal Frequency Division Multiplexing) in the DL and both CP-OFDM and DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz, with even greater SCS considered for future NR releases.

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

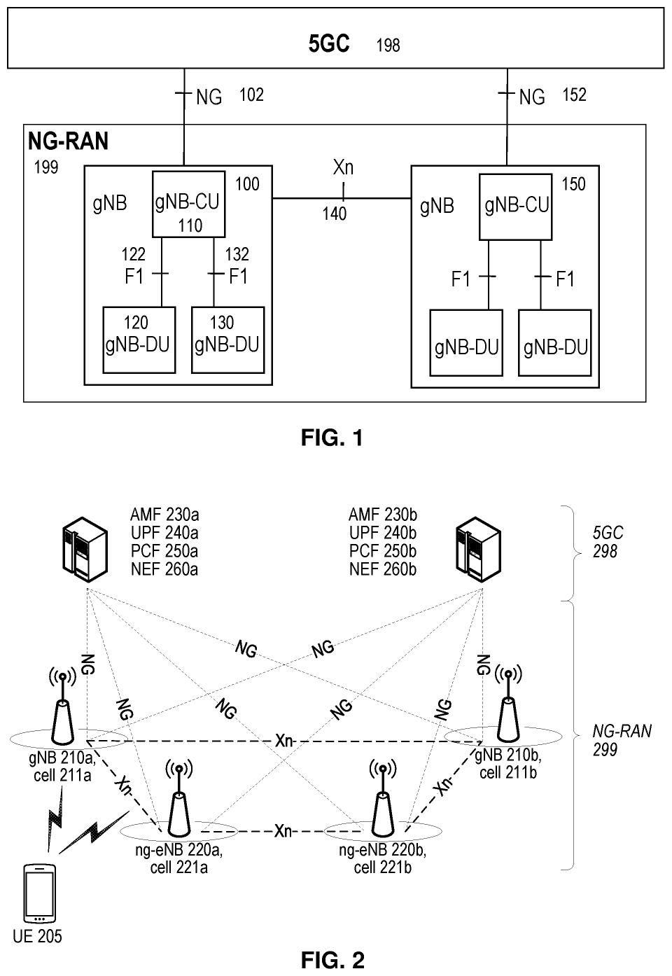

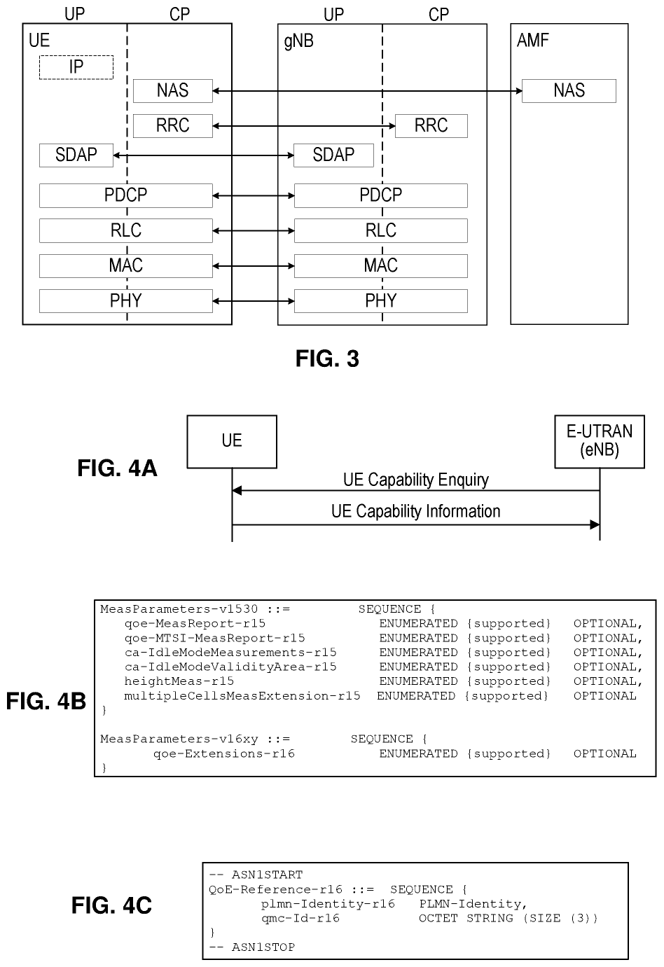

FIG. 3 shows an exemplary configuration of NR user plane (UP) and control plane (CP) protocol stacks between a UE, a gNB, and an AMF, such as those shown in FIGS. 1-2. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QOS) including mapping between QoS flows and Data Radio Bearers (DRBs) and marking QoS flow identifiers (QFI) in UL and DL packets. The RLC layer transfers PDCP PDUs to the MAC through logical channels (LCH). RLC provides error detection/correction, concatenation, segmentation/reassembly, sequence numbering, reordering of data transferred to/from the upper layers. The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

As briefly mentioned above, measurements were specified for UEs operating in earlier-generation LTE and UMTS networks and are being specified in 3GPP for UEs operating in NR networks. Measurements in all of these networks operate according to similar high-level principles, with the purpose of measuring the end-user experience for certain applications over the network. For example, QoE measurements for streaming services and for MTSI (Mobility Telephony Service for IMS) are supported in LTE and NR networks.

QoE measurements may be initiated towards the RAN from an OAM node generically for a group of UEs (e.g., all UEs meeting one or more criteria), or they may also be initiated from the CN to the RAN for a specific UE. The configuration of the measurement includes the measurement details, which is encapsulated in a container that is transparent to RAN.

A “TRACE START” SIAP message is used by the LTE EPC for initiating QoE measurements by a specific UE. This message carries details about the measurement configuration the application should collect in the “Container for application-layer measurement configuration” IE, which transparent to the RAN. This message also includes details needed to reach the TCE to which the measurements should be sent.

FIGS. 4A-C illustrate a procedure between an E-UTRAN and a UE for configuring QoE measurements in an LTE network. FIG. 4A shows an exemplary UE capability transfer procedure used to transfer UE radio access capability information from the UE to E-UTRAN. Initially, the E-UTRAN can send a UECapabilityEnquiry message. The UE can respond with a UECapabilityInformation message that includes a “UE-EUTRA-Capability” IE.

This IE may further include a UE-EUTRA-Capability-v1530 IE, which can be used to indicate whether the UE supports QoE Measurement Collection for streaming services and/or MTSI services. In particular, the UE-EUTRA-Capability-v1530 IE can include a measParameters-v1530 IE containing the information about the UE's measurement support. In some cases, the UE-EUTRA-Capability IE can also include a UE-EUTRA-Capability-v16xy-IE”, which can include a qoe-Extensions-r16 field. FIG. 4B shows an exemplary ASN.1 data structure for these various IEs, with the various fields defined in Table 1 below.

TABLE 1

| Field name | Description |
|---|---|
| qoe-MeasReport | Indicates whether the UE supports QoE Measurement Collection for |
| | streaming services. |
| qoe-MTSI-MeasReport | Indicates whether the UE supports QoE Measurement Collection for |
| | MTSI services. |
| qoe-Extensions | Indicates whether the UE supports the Rel-16 extensions for QoE |
| | Measurement Collection, i.e., support of more than one QoE |
| | measurement type at a time and signaling of withinArea, |
| | sessionRecordingIndication, qoe-Reference, temporaryStopQoE and |
| | restartQoE |
| temporaryStopQoE | Indicates that reporting, but not collection, of QoE measurements |
| | shall be temporarily stopped. |
| withinArea | Indicates at handover, for each application-layer measurement, |
| | whether the new cell is inside the area for the measurement, i.e., |
| | whether the UE is allowed to start new measurements in the cell |
| restartQoE | Indicates that QoE measurements can be reported again after a |
| | temporary stop. |

FIG. 4C shows an exemplary ASN.1 data structure for the qoe-Reference parameter mentioned in Table 1 above.

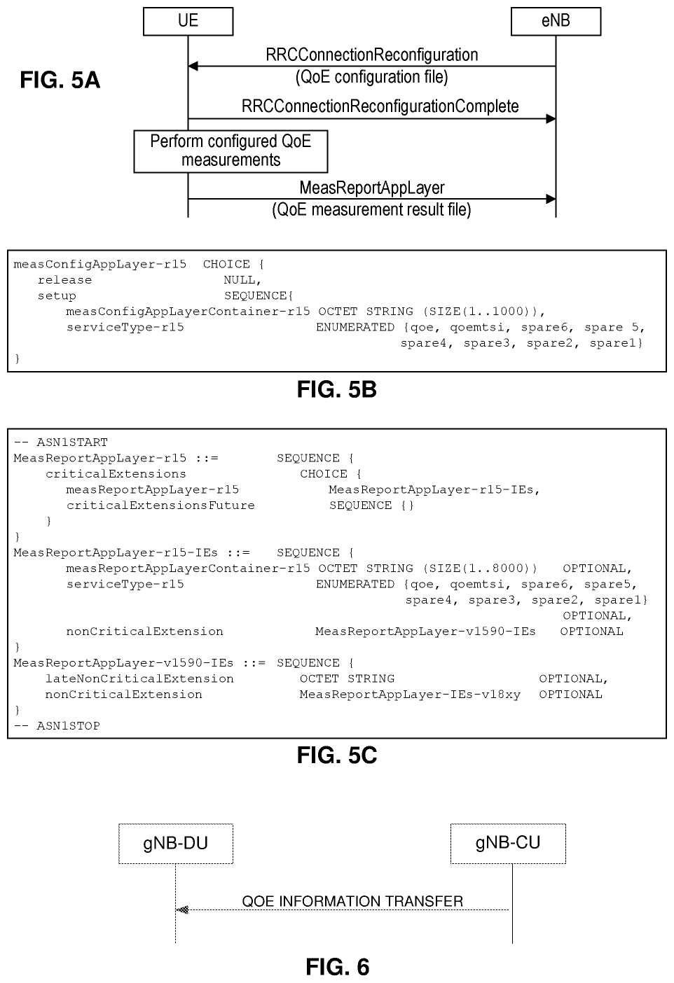

FIGS. 5A-C illustrate various aspects of QoE measurement collection for a UE in an LTE network. In particular, FIG. 5A shows an exemplary signal flow diagram of a QoE measurement collection process for LTE. To initiate QoE measurements, the serving eNB sends to a UE in RRC CONNECTED state an RRCConnectionReconfiguration message that includes a QoE configuration file, e.g., a measConfigAppLayer IE within an OtherConfig IE. As discussed above, the QoE configuration file is an application layer measurement configuration received by the eNB (e.g., from EPC) encapsulated in a transparent container, which is forwarded to UE in the RRC message. The UE responds with an RRCConnectionReconfigurationComplete message.

Subsequently, the UE performs the configured QoE measurements and sends a MeasReportAppLayer RRC message to the eNB, including a QoE measurement result file. Although not shown, the eNB can forward this result file transparently (e.g., to EPC). More specifically, if the UE has been configured with SRB4, the UE can:
set the measReportAppLayerContainer in the MeasReportAppLayer message to the value of the application layer measurement report information;
set the serviceType in the MeasReportAppLayer message to the type of the application layer measurement report information; and
submit the MeasReportAppLayer message to lower layers for transmission via SRB4.

FIG. 5B shows an exemplary ASN.1 data structure for a measConfigAppLayer IE. The setup includes the transparent container measConfigAppLayerContainer which specifies the QoE measurement configuration for the Application of interest. In the service Type field, a value of “qoe” indicates Quality of Experience Measurement Collection for streaming services and a value of “qoemtsi” indicates Enhanced Quality of Experience Measurement Collection for MTSI. This field also includes various spare values.

FIG. 5C shows an exemplary ASN.1 data structure for a measReportAppLayer message or IE, by which a UE can send to the E-UTRAN (e.g., via SRB4) the QoE measurement results of an application (or service). The service for which the report is being sent is indicated in the service Type IE.

U.S. App. 63/092,984 by the present Applicant(s) discloses “lightweight” QoE measurements and various techniques for transmitting, receiving, and using the same. In particular, lightweight QoE measurements can be obtained by converting one or more QoE measurements logged in a conventional (or legacy) format into one or more lightweight QoE metrics. For example, each lightweight QoE metric can represent of one of the following:
a conventional QoE metric;
a plurality of different conventional QoE metrics for one application;
a plurality of different lightweight QoE metrics for one application;
respective values of a conventional QoE metric for a plurality of applications, and
respective values of a lightweight QoE metric for a plurality of applications.

Each representation used by a lightweight QoE metric can be a concatenation, an index, a score, a rating based on enumerated values, a binary relation to a threshold, etc. Each conventional QoE metric represented by a lightweight QoE metric can relate to one or more of the following characteristics:
throughput per TCP socket or per access bearer, (e.g., average, max/min, standard deviation, etc.);
end to end latency (e.g., average, max/min, standard deviation, etc.);
round trip time (e.g., average, max/min, standard deviation, instant value, etc.);
uplink delay (e.g., average, max/min, standard deviation, instant value, etc.);
downlink delay (e.g., average, max/min, standard deviation, instant value, etc.);
jitter of arriving packets (e.g., average, max/min, standard deviation, instant value, etc.);
number of consecutive failures in receiving the packets (e.g., average, max/min, standard deviation, instant value, etc.);
initial playout delay;
timeliness of the packets (e.g., average, max/min, standard deviation, instant value, etc.);
application level buffer (e.g., average, max/min, standard deviation, instant value, etc.).

There are various ways to derive lightweight QoE metrics, and lightweight QoE metrics can be derived from a single conventional QoE metric or from multiple (e.g., all) conventional QoE metrics for an application. An example of the former is a lightweight representation of the average throughput (AvgThroughput) conventional QoE metric and a lightweight representation of the initial playout delay (InitialPlayoutDelay) conventional QoE metric for Progressive Download and DASH. An example of the latter is a lightweight QoE metric that represents both of these conventional QoE metrics. As another example, different subsets of conventional QoE metrics for an application can be represented by respective lightweight QoE metrics. Each subset can include one or more conventional QoE metrics.

In addition to conventional or legacy QoE metrics, 3GPP has introduced so-called “RAN-visible” (or RV, for short) QoE metrics and QoE values. For example, RVQoE measurements are supported for DASH streaming and virtual reality (VR) services. In general, RVQoE metrics are a subset of legacy QoE metrics collected from UE and RVQoE values are derived from legacy QoE metrics through a model and/or function. Both of these are RAN-visible because they are useful (in some way) to the RAN (e.g., NG-RAN). A general description of RVQoE measurements and related procedures is given in 3GPP TS 38.300 (v17.0.0) section 21.4, the entirety of which is incorporated herein by reference. RVQOE metrics and values can be considered a form of lightweight QoE metrics previously disclosed by Applicant in U.S. App. 63/092,984.

QoE measurements are configured by an NG-RAN node, with the RVQoE subset being reported by the UE as an explicit IE that is readable by the NG-RAN node. RVQoE measurements or metrics could be utilized by the NG-RAN node for network optimization. The PDU session ID(s) corresponding to the service that is subject to QoE measurements can also be reported by the UE along with the RAN visible QoE measurement results.

A request for collecting legacy QoE measurements not visible to NG-RAN (also called OAM-QoE) is initiated by the operations/administration/maintenance (OAM) system associated with the NG-RAN. Each OAM request is identified by a QoE Reference, a globally unique parameter that specifies a network request session. The QoE reference includes a mobile country code (MCC) and a mobile network code (MNC), which collectively identify the public land mobile network containing the OAM system. The QoE reference also includes a QoE measurement collection (QMC) identifier (ID), a three-byte (or octet) string generated by the OAM system or the network operator. QMC ID identifies the QoE measurement request within the network, including the NG-RAN nodes and the measurement collection entity (MCE).

A UE's application layer can be configured to perform multiple QoE application layer measurements concurrently (up to 16 in Rel-17). Each UE application layer measurement is identified by a MeasConfigAppLayerId IE or field. The UE access stratum (AS, or access layer) reports RVQoE measurements via RRC to the serving gNB.

In the split-node architecture shown in FIG. 1, an RVQoE measurement report from a UE is received by a gNB-CU, specifically a CU-CP that hosts the RRC layer. The CU-CP can send the received RVQoE measurements to another unit or function of the gNB, e.g., a gNB-DU. FIG. 6 shows a signaling diagram of an exemplary QoE Information Transfer procedure, whereby a gNB-CU provides RVQoE measurements to a gNB-DU (i.e., within the same gNB), which hosts lower-layer protocols that could benefit from the RVQoE measurements made by UEs served by the gNB-DU. The QoE Information Transfer message shown in FIG. 6 is based on F1AP UE-associated signaling, which means it contains measurements only for a single UE.

Table 1 below shows the contents of the exemplary QoE Information Transfer message shown in FIG. 6, while Table 2 shows the contents of a QoE Metrics IE included in the message. In particular, the QoE Metrics IE contains the UE's RVQoE measurement report. Note that up to maxnoofQoEInformation (=16) QoE Metrics IEs can be included in a single QoE Information Transfer message.

TABLE 1

| | | | | | |
|---|---|---|---|---|---|
| | | | | | Assigned |
| IE/Group Name | Pres. | Range | IE type/ref. | Criticality | Criticality |

| | | | | |
|---|---|---|---|---|
| Message Type | M | 9.3.1.1 | YES | ignore |
| gNB-CU UE F1AP ID | M | 9.3.1.4 | YES | reject |
| gNB-DU UE F1AP ID | M | 9.3.1.5 | YES | reject |
| QoE Information List | | 0 . . . 1 | YES | ignore |
| >QoE Information Item | | 1 . . . <maxnoofQoEInformation> | Each | ignore |
| >>QoE Metrics | O | 9.3.1.260 | — | — |

TABLE 2

| | | | | |
|---|---|---|---|---|
| IE/Group Name | Pres. | Range | IE type/ref. | Semantics description |

| | | | |
|---|---|---|---|
| Buffer Level | O | OCTET STRING | As defined in TS 38.331 [8]. |
| Playout Delay | O | OCTET STRING | As defined in TS 38.331 [8]. |

As illustrated above, RVQoE metric(s) sent via QoE Information Transfer message are not accompanied by any reference or other type of identifier. As such, the receiving gNB-DU is unable to distinguish between QoE reports coming from the different UE application sessions and will be unaware of how many different UE application sessions are being reported. Also, the gNB-DU will be unable to group successive RVQoE metrics reported for a particular UE application session and thus will be unable to trace or detect patterns in the reported RVQoE metrics.

One possible solution to this problem is to include the MeasConfigAppLayerId IE discussed above, which is allocated by the UE application layer. However, there could be some problems, issues, and/or difficulties with this solution that need further investigation.

In some cases, a UE can be configured to collect RVQoE measurements for many different applications. Likewise, in some cases, the number of RVQoE measurements collected by the UE can be large. In such cases, the flow of RVQOE measurements within a gNB can become quite large and the recipient(s) may receive measurements that are unnecessary and/or unable to be processed.

As a specific example, a CU-CP configures UEs (via RRC) for RVQoE measurements with a reporting periodicity and forwards received RVQoE measurements to the relevant DU via F1AP. The information that arrives at the DU can be irrelevant, the DU may be unable to use the RVQoE reports related to a particular application, or the DU can be close to overload in processing resources.

Likewise, the CU-CP can send the received RVQoE measurements to a unit or function of a different gNB, e.g., a CU-CP of a second gNB that is engaged in a mobility operation or multi-connectivity with the UE. This can be done via XnAP signaling similar to the F1AP signaling shown in FIG. 6. The recipient CU-CP of the second gNB may have similar conditions as the recipient DU, discussed above.

However, there currently is no way to control the flow of this RVQoE information within a gNB and between gNBs (or other RAN nodes).

Accordingly, embodiments of the present disclosure provide flexible and efficient techniques for coordination between a first network node or function (NNF) and a second NNF in a communication network, so that RVQoE measurements (e.g., RVQoE metrics and/or RVQOE values) can be distributed or transferred in a controlled manner from the second NNF to the first NNF. For example, RVQoE measurements can be requested by the NNF or offered by the second NNF. In this manner, embodiments enable transfer of RVQoE measurements between NNFs (e.g., RAN nodes or functions of a RAN node) in a controlled manner, thereby avoiding excess signaling of unwanted and/or unusable RVQoE measurements.

In this manner, embodiments can facilitate a RAN node to receive UE application-related information that it can understand and use for radio network optimization tasks. Examples of RAN use cases that can benefit from such application-related information include QoE-aware traffic steering, scheduling and link adaptation, mobility-related decisions, mobility decision evaluation, and inputs to AI/ML algorithms used for network optimization and/or fault prediction. By improving RAN performance by the reporting of RAN-visible QoE measurements in this manner, embodiments facilitate improved RAN performance as experienced by applications and end users.

As a high-level summary, embodiments include (but are not limited to) the following aspects or features:
coordination between the first and second NNFs for managing the second NNF sending to the first NNF of RVQOE measurement results available at the second NNF.
the second NNF determining to send RVQoE measurement results to the first NNF, e.g., based on a subscription requested by the first NNF (implicitly or explicitly acknowledged by the second NNF).
the second NNF sending RVQoE measurement results to the first NNF, including a non-UE associated message used for sending RVQoE measurement results from the second NNF to the first NNF. Alternately, a UE-associated message can be used to send RVQoE measurement results from the second NNF to the first NNF, but including additional information than conventional UE-associated messages.
the second NNF sending RVQoE assistance information to the first NNF, some of which may be legacy information such as QoE Reference, MeasConfigAppLayerId, PDU Session ID, DRB ID, etc.
the second NNF requesting the first NNF to send the RVQOE associated feedback information to the second NNF.
upon/after reception of RVQoE measurement results, the first NNF sending RVQoE associated feedback information.
signaling configuration related to transfer of RVQoE measurements and/or RVQoE related capability, such as managing RVQoE related configuration parameters and/or RVQOE related capability information for the first NNF, the second NNF and between the first and second NNFs.

In the following description of embodiments, the following groups of terms and/or abbreviations have the same or substantially similar meanings and, as such, are used interchangeably and/or synonymously unless specifically noted or unless a different meaning is clear from a specific context of use:
“application layer” and “UE application layer” (RAN nodes generally do not have an application layer);
“application-layer measurement”, “application measurement”, and “QoE measurement”;
“QoE measurement report”, “QoE report”, “measurement report”, and “report”;
“QoE measurement configuration”, QoE measurement and reporting configuration”, “QoE measurement”, “QoE configuration”, and “application layer measurement configuration”;
“modem”, “radio layer”, “radio network layer”, “access stratum”, and “AS”;
“radio layer connection” and “RRC connection”;
“UE RRC configuration”, “RRC configuration”, “UE RRC context”, “RRC context”, “context”;
“service” and “application”;
“subservice type” and “service subtype”;
“measurement collection entity”, “MCE”, “trace collection entity”, and “TCE”;
“report” and “measurement report”;
“results” and “measurement results”.

The term “RAN visible QoE” (or “RVQoE”) may refer to RAN visible QoE measurements, RAN visible QoE measurement reporting, RAN visible QoE parameters and metrics, processing of information to derive RAN visible QoE parameters/metrics/information/data, and an overall framework for these and related activities. The term “RVQoE report” refers to a QoE report that includes RVQOE metrics and/or RVQOE values. An RVQoE report can be associated with one or more service types, one or more network slices, one or more service subtypes, one or more subservice types, etc.

As used herein, the term “conventional QoE metric” (or “legacy QoE metric”) refers to any of the QoE measurements specified in 3GPP TS 26.247 (v16.4.1), 26.114 (v16.7.0), 26.118 (v16.0.2), and 26.346 (v16.6.0) that are delivered from the UE to a network entity via the RAN, particularly when the RAN is unable to read the QoE reports containing the measured values of these metrics.

In contrast, the RAN is able to read, decode, understand, and/or interpret RVQoE metrics and/or RVQoE values included in QoE reports. The RVQoE metrics and values can be carried in information elements (IEs) of protocol messages, including RRC and inter-node signaling protocols. RVQOE metrics and values can be representations (e.g., in modified, adapted, or otherwise processed forms) of at least one conventional (or legacy) QoE metric as that term is defined above. Each representation can be condensed, compact, simplified, and/or more abstract with respect to the conventional QoE metric(s). For each, a RVQoE metric or value can require fewer information bits to transmit than corresponding conventional QoE metric(s).

The term “UE-associated signaling” (or “UE associated message”) refers to a message sent via an interface between NNFs, where the message includes a UE ID assigned by one of the NNFs. The message pertains only to the UE identified by the UE ID. As one example, an F1AP message between gNB-CU and gNB-DU includes a gNB-CU UE F1AP ID and/or a gNB-DU UE F1AP ID. As another example, an XnAP message between a source NG-RAN node (e.g., gNB1) and a target NG-RAN node (e.g., gNB2) includes a source NG-RAN node UE XnAP ID and/or a target NG-RAN node UE XnAP ID.

In contrast, the term “non-UE associated signaling” (or “non-UE-associated message”) refers to a message between NNFs that does not include a UE ID but includes a measurement ID, i.e., associated with measurements conveyed in the message. As one example, an F1AP message between gNB-CU and gNB-DU includes gNB-CU Measurement ID and/or a gNB-DU Measurement ID. As another example, an XnAP message between a source NG-RAN node (e.g., gNB1) and a target NG-RAN node (e.g., gNB2) includes a source NG-RAN node Measurement ID and/or a target NG-RAN node Measurement ID.

Although embodiments may be described below in the context of streaming services, they are equally applicable to other types of services such as services whose QoE metrics are a subset or a superset of the QoE metrics defined for the streaming service

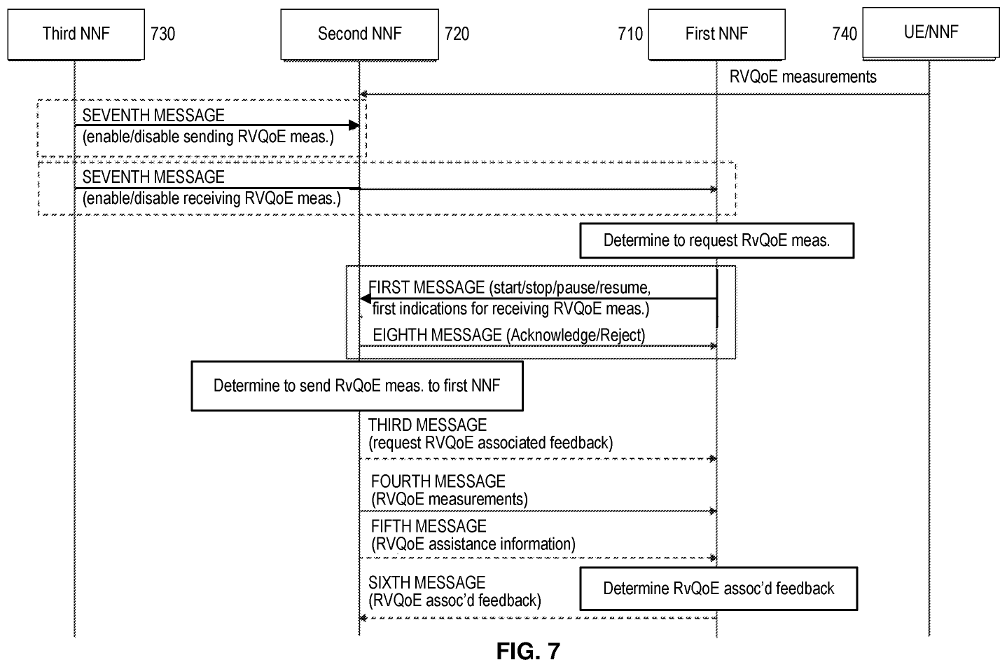

In a first group of embodiments, the coordination for sending RVQOE measurements results from the second NNF to the first NNF is initiated by the first NNF. FIG. 7 shows a signaling diagram between the first NNF (710), the second NNF (720), a third NNF (730), and a UE or NNF (740) according to these embodiments. Note that the NNF (740) can be any NNF that can send or forward RVQoE measurements (e.g., CN node, OAM node, RAN node, AF, SMO node, etc.).

The first NNF determines a need for requesting RVQoE measurements from the second NNF. Variants of this operation will be described in more detail below. The first NNF sends to the second NNF a FIRST MESSAGE comprising one or more of the following:
a request (e.g., a subscription request) to setup/start/stop/pause/resume/modify/release the sending of RVQoE measurements from the second NNF to the first NNF.
one or more first indications for requesting RVQoE measurements from the second NNF. It should be understood that the first NNF can send more than one FIRST MESSAGE, such as an initial FIRST MESSAGE including a request to start sending RVQoE measurements and a subsequent FIRST MESSAGE including a request to stop sending RVQoE measurements.

The second NNF can implicitly or explicitly acknowledge/confirm or refuse/reject the request from the first NNF, e.g., using an EIGHTH message. In case of unsuccessful procedure (refuse/reject), the EIGHTH message can comprise an indication of the reason (cause value) for the failure. The second NNF can determine to send RVQoE measurements in response to the FIRST message, and send RVQoE measurements to the first NNF in a FOURTH MESSAGE. In some embodiments, the second NNF can send a THIRD MESSAGE that requests RVQoE-associated feedback from the first NNF, e.g., in relation to the FOURTH message. The THIRD MESSAGE may indicate which type(s) of RVQoE associated feedback the second NNF wants to receive.

If requested to do so by the second NNF in the THIRD MESSAGE, the first NNF determines RVQOE associated feedback sends it to the second NNF using a SIXTH MESSAGE. In some embodiments, the second NNF can send a FIFTH MESSAGE that provides RVQoE assistance information to the first NNF, which can use such information in determining and/or sending the RVQoE-associated feedback.

Note that the THIRD MESSAGE may also be sent before the determination to send RVQOE measurements to the first NNF. Furthermore, the THIRD MESSAGE may be combined with the EIGHTH MESSAGE to form a single message. Likewise, the THIRD MESSAGE may be combined with the FOURTH MESSAGE to form a single message.

Note that other variations of the signaling shown in FIG. 7 are also possible. For example, the THIRD MESSAGE, the FOURTH MESSAGE and the FIFTH MESSAGE may be combined in various ways. The THIRD MESSAGE and the FOURTH MESSAGE may be combined into one message, sent before or after the FIFTH MESSAGE. The FOURTH MESSAGE and the FIFTH MESSAGE may be combined into one message, sent before or after the THIRD MESSAGE. The THIRD MESSAGE and the FIFTH MESSAGE may be combined into one message, sent before or after the FOURTH MESSAGE. The THIRD MESSAGE, the FOURTH MESSAGE and the FIFTH MESSAGE may all be combined into one message. As another example, even if the THIRD MESSAGE, the FOURTH MESSAGE, and the FIFTH MESSAGE are separate messages, they may be sent/received in various orders.

Other messages, message contents, and/or operations shown in FIG. 7 are also included in other groups of embodiments and, as such, will be described below in the context of these embodiments.

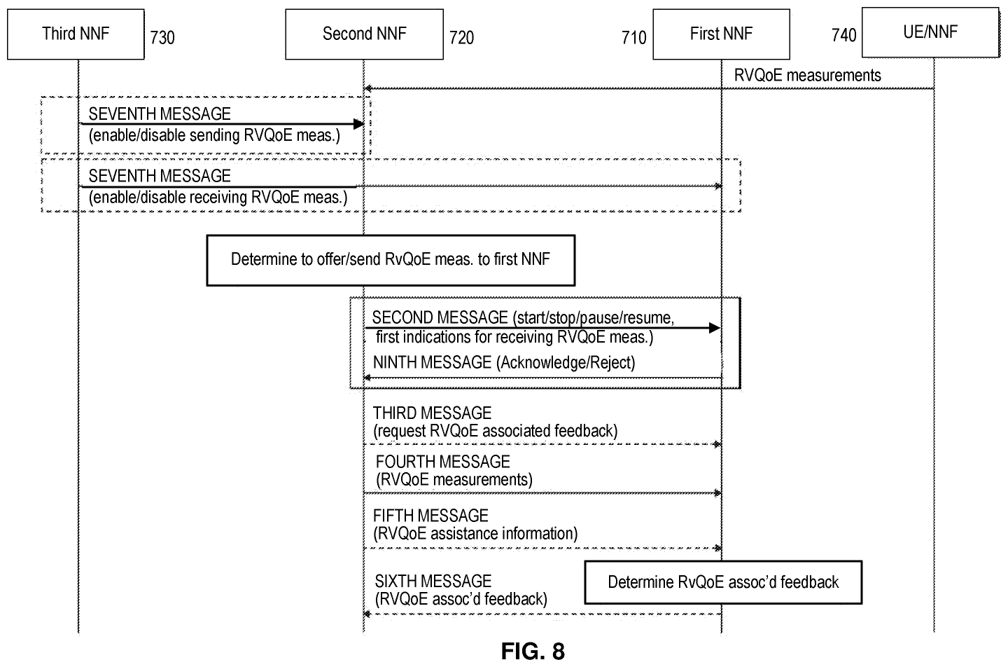

In a second group of embodiments, the coordination for sending RVQoE measurements results from the second NNF to the first NNF is initiated by the second NNF. FIG. 8 shows a signaling diagram between the first NNF (710), the second NNF (720), the third NNF (730), and the UE or NNF (740) according to these embodiments. As described above, the NNF (740) can be any NNF that can send or forward RVQoE measurements (e.g., CN node, OAM node, RAN node, AF, SMO node, etc.).

The second NNF determines a need to offer/send RVQoE measurements to the first NNF. Variants of this operation will be described in more detail below. The second NNF sends to the first NNF a SECOND MESSAGE comprising one or more of the following:
an offer (e.g., a subscription offer) to setup/start/stop/pause/resume/modify/release the sending of RVQoE measurements from the second NNF to the first NNF. The offer may contain an indication of availability or unavailability of RVQoE measurements at the second NNF.
one or more second indications for offering RVQOE measurements to the first NNF.

The first NNF can implicitly or explicitly acknowledge/confirm or refuse/reject the offer from the second NNF, e.g., using a NINTH message. In case of refuse/reject, the NINTH message can include an indication of the reason (cause value) for the failure. In some embodiments, the NINTH message may also indicate which part(s) of the offer the first NNF accepts or rejects. This indication in the NINTH MESSAGE may also function as an implicit request to receive available RVQOE measurement results indicated in the SECOND MESSAGE from the second NNF.

For example, the second NNF may indicate that it has RVQoE measurement results available for metrics X and Y. In its response, the first NNF may indicate that it wants the second NNF to send the RVQOE measurement results for metric X but not for metric Y. The first NNF may further indicate that it also wants to receive future RVQOE measurement results for metric X. In some embodiments, the NINTH message may also include a request for RVQoE measurements from the second NNF, e.g., for different RVQoE measurements than offered in the SECOND MESSAGE.

In response to the NINTH MESSAGE, the second NNF can send RVQoE measurements to the first NNF in a FOURTH MESSAGE. In some embodiments, the second NNF can send a THIRD MESSAGE that requests RVQoE-associated feedback from the first NNF, e.g., in relation to the FOURTH message. In some embodiments, the second NNF can send a FIFTH MESSAGE that provides RVQoE assistance information to the first NNF.

The signaling shown in FIG. 8 can include various other messages described above in relation to FIG. 7. Moreover, similar variations can be applied to the signaling shown in FIG. 8 as described above in relation to FIG. 7.

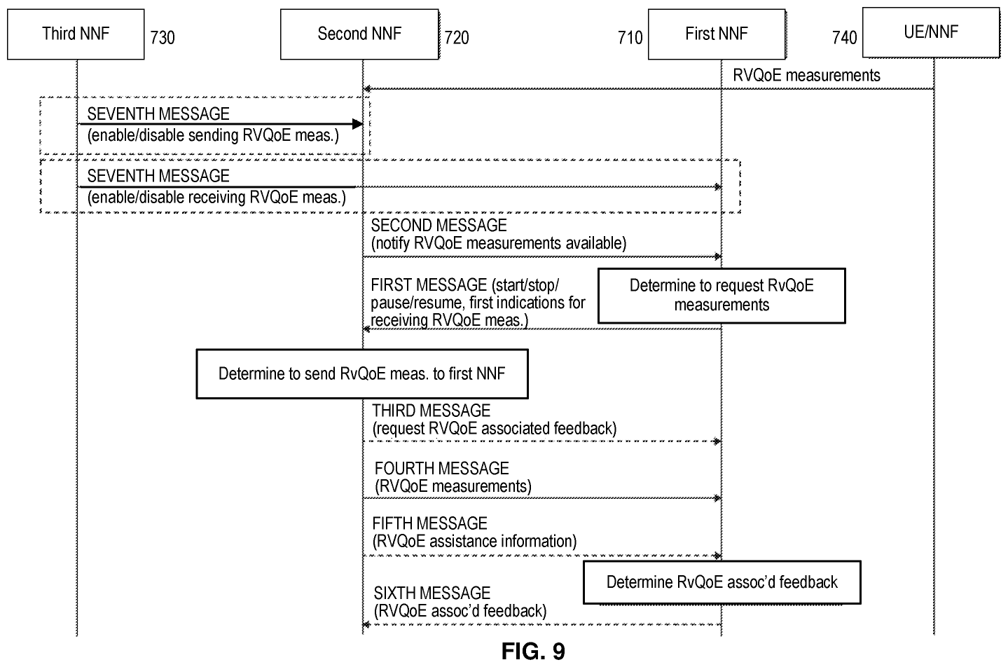

FIG. 9 shows a signaling diagram between the first NNF (710), the second NNF (720), the third NNF (730), and the UE or NNF (740, according to a third group of embodiments. As described above, the NNF (740) can be any NNF that can send or forward RVQoE measurements (e.g., CN node, OAM node, RAN node, AF, SMO node, etc.).

In these embodiments, the first NNF receives from the second NNF a SECOND MESSAGE comprising a notification to inform the first NNF that RVQoE measurements are available (or unavailable) at the second NNF. The first NNF sends to the second NNF a FIRST MESSAGE comprising a request (e.g., a subscription request) to setup/start/stop/pause/resume/modify/release the sending of RVQoE measurements from the second NNF to the first NNF.

The signaling shown in FIG. 9 can include various other messages described above in relation to FIGS. 7-8. Moreover, similar variations can be applied to the signaling shown in FIG. 9 as described above in relation to FIGS. 7-8.

In any of the groups of embodiments described above, the first NNF may receive a SEVENTH MESSAGE from a third NNF, which may be part of a core network (e.g., 5GC) or an OAM system. The SEVENTH MESSAGE may include an indication (e.g., request) to enable/disable/start/stop/pause/resume/modify reception of RVQoE measurements by the second NNF from the first NNF, and/or other information that can be used by the first NNF for requesting RVQOE measurements from the second NNF.

In various embodiments, RVQOE assistance information sent from the second network node to the first network node in the FIFTH MESSAGE can be used by the first NNF for any of the following operations:
to identify RVQoE reports and distinguish them;
to align RVQoE reports with other information, e.g., radio measurements;
to determine actions concerning a UE or a group of UEs (e.g., to increase the radio resources to assign for the UE)·
to identify RVQoE sessions (and/or related application sessions);
to identify starts and stops of RVQoE sessions (and/or related application sessions);
to determine which RVQoE metrics the RVQoE measurement results are associated with, which may be used for determining RVQoE metric-related conditions in a request for RVQoE measurement results (e.g., conditions that should be fulfilled for the second network node to send the RVQoE measurement results to the first network node in accordance with the request);
to identify data radio bearers (DRBs) which may carry the application data flows to which the RVQoE measurements are related, which may be used as input to scheduling decisions; and
to identify data flows constituting the application data flows RVQoE measurements pertain to, which may be used as input to scheduling decisions.

In various embodiments, the RVQOE assistance information in the FIFTH MESSAGE can include any of the following:
QoE Reference(s), UE Identifier(s), UE group Identifier(s), Trace Recording Session Reference(s), alignment indications, application session identifier(s) (e.g., recording session IDs, session start/stop indications), PDU Session IDs, MeasConfigAppLayerId;
network slice IDs, cell identifiers (e.g., NR CGI), reference signal beam identifiers (e.g., SSB Index), DRB IDs, type of communication path (uplink, downlink, both uplink and downlink);
available RVQoE metrics (possibly indicated in terms of an index of one of a set of reference RVQoE measurement configurations or an index of one of a number of sets of RVQoE metrics; and/or
data flow identifiers, e.g., source IP address, destination IP address, transport source port number, transport destination port number, and/or type of transport protocol.

In various embodiments, the RVQOE associated feedback in the SIXTH MESSAGE can include any of the following:
Indication(s) of whether RVQoE measurements have been used by the first NNF;
indications of how RVQoE measurements have been used. For example: an action determined based at least in part on the RVQoE measurements (e.g., indicated by an action identity), a use case for which the RVQOE measurements have been used (e.g., energy saving), whether RVQoE measurements have been used for alignment of RVQoE to radio measurements
indications of how actions taken by the first NNF based on the received RVQoE measurements affected performance of the UE(s) that made the RVQoE measurements (e.g., positive, negative, no effect).
   The first NNF may send RVQoE associated feedback in multiple SIXTH MESSAGES, since feedback information may be created repeatedly and at different time points. For instance, received RVQoE measurement results (e.g., in one or more THIRD MESSAGES) may impact multiple scheduling decisions and/or multiple choices of Modulation and Coding Scheme (MCS) over time. These effects can be reported in multiple SIXTH MESSAGES or in multiple portions of a single SIXTH MESSAGE sent at various times.

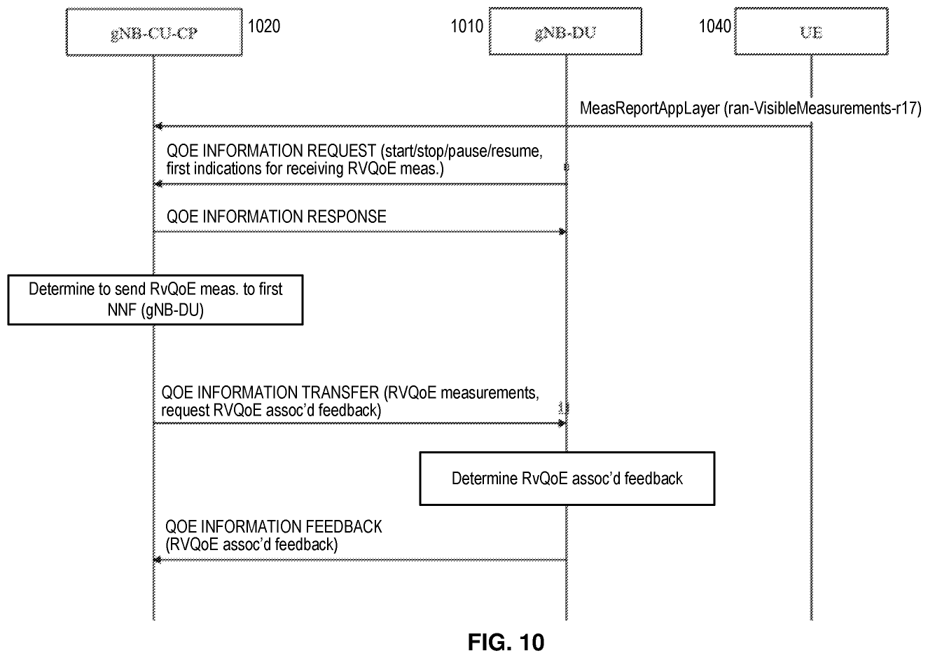

FIG. 10 is a diagram of a particular embodiment of the signaling procedures described above, where the first NNF is a gNB-DU (1010) and the second NNF is a gNB-CU-CP (1020). A UE (1040) initiates the procedure with a MeasReportAppLayer message that includes a ran-VisibleMeasurements-r17 IE. The FIRST MESSAGE described above is realized as a QoE Information Request messages, the EIGHTH MESSAGE is realized as a QoE Information Response message, the THIRD MESSAGE and the FOURTH MESSAGE are realized as a single QoE Information Transfer message, and the SIXTH MESSAGE is realized as a QoE Information Feedback message. All of these messages are part of, or can be added to, the F1AP protocol.

In various embodiments, the FIRST MESSAGE sent by the first NNF to request RVQoE measurements from the second NNF, the FOURTH MESSAGE sent by the second NF to provide RVQOE measurements, the SECOND MESSAGE sent by the second NNF to offer RVQoE measurements, and the NINTH message sent by the first NNF in response to such offer can include a list of RVQoE measurements provided, requested, offered, etc. with each RVQoE measurement identified by one of the following:
MeasConfigAppLayerId.
Recording Session ID, which is a QoE measurement session identifier that the UE application layer generates when a QoE measurement session is initiated. It may also be used to identify the corresponding RVQoE measurement session.
MeasConfigAppLayerId combined with a Recording Session ID.
QoE reference, optionally combined with a Recording Session ID.
One or more UE IDs that identify a UE-associated signaling connection that carries the message, e.g., gNB-CU UE F1AP ID, gNB-DU UE F1AP ID, or both.
One or more UE IDs, combined with a MeasConfigAppLayerId and/or a Recording Session ID.
One or more UE IDs, combined with a QoE reference and/or a Recording Session ID.

In some embodiments, the FIRST MESSAGE sent by the first NNF to request RVQoE measurements from the second NNF and the SECOND MESSAGE sent by the second NNF to offer RVQoE measurements can indicate to include or exclude all RVQoE measurements available at second NNF. As one option, indication of all RVQoE measurements may be used when the message carrying the indication is conveyed using UE-associated signaling. In this case, the indication of all RVQoE measurements refers to all RVQoE measurement results produced by and sent from the associated UE.

As another option (which may be used in parallel with the above option), indication of all RVQoE measurements may be used when the message carrying the indication is conveyed using non-UE associated signaling. In this case, the indication of all RVQOE measurements refers to all RVQoE measurement results produced by any (or all) UEs that are associated with the first NNF (e.g., gNB-DU) or the second NNF (e.g., gNB-CU).

In some embodiments, the FIRST MESSAGE sent by the first NNF to request RVQoE measurements from the second NNF and the SECOND MESSAGE sent by the second NNF to offer RVQoE measurements can indicate to include RVQoE measurements that are associated with signaling-based QoE measurement configurations and/or management-based QoE measurement configurations. Depending on whether the relevant message is conveyed by UE-associated and non-UE-associated signaling, similar options as described above are also available for these embodiments.

In some embodiments, the FIRST MESSAGE sent by the first NNF to request RVQoE measurements from the second NNF and the SECOND MESSAGE sent by the second NNF to offer RVQoE measurements can indicate to include RVQoE measurements from all UEs served by the first NNF that are configured for RVQoE. For example, the first NNF is a gNB-DU, the second NNF is gNB-CU-CP controlling the gNB-DU, and the gNB-DU wants to receive RVQoE measurements available at the gNB-CU-CP for all UEs being served by the gNB-DU. Note that this type of indication is the most useful when non-UE associated signaling is used between the first NNF and the second NNF.

For example, the indication to include RVQoE measurements from all UEs served by the first NNF that are configured for RVQOE can be an identifier of the first NNF (e.g., a gNB-DU ID). Alternately, such an indication can be implicit without an identifier of the first NNF, since the second NNF knows the identity of the first NNF that it is communicating with.

In some embodiments, the FIRST MESSAGE sent by the first NNF to request RVQoE measurements from the second NNF and the SECOND MESSAGE sent by the second NNF to offer RVQoE measurements can indicate to include RVQOE measurements from all UEs associated with (or served by) the second NNF that are configured for RVQoE. For example, when the first NNF is a first gNB, the second NNF is a second gNB), and the first gNB wants to receive RVQOE measurements available at the second gNB before a UE mobility event from the second gNB to the first gNB. Note that this type of indication is useful when UE-associated signaling is used between the first NNF and the second NNF.

In some embodiments, the FIRST MESSAGE sent by the first NNF to request RVQoE measurements from the second NNF and the SECOND MESSAGE sent by the second NNF to offer RVQOE measurements can indicate to include RVQoE measurements associated with one or more of the following: one or more particular cells (e.g., Cell ID, CGI, SpCell ID, etc.), one or more particular RS or beams (e.g., SSB indices), one or more particular PLMNs and/or Tracking Areas, one or more particular network slices (e.g., S-NSSAI), one or more particular PDU Sessions, one or more particular DRBs (e.g., DRB IDs), one or more particular data flows (e.g., QOS Flow Identifier, QoS Class Indicator, 5QI, or other QoS parameters).

In some embodiments, the FIRST MESSAGE sent by the first NNF to request RVQoE measurements from the second NNF and the SECOND MESSAGE sent by the second NNF to offer RVQoE measurements can indicate to include RVQoE measurements associated with one or more of the following:
a particular communication direction between a UE and a NNF (e.g., UL or DL);
a particular communication path (e.g., a particular BAP routing ID through an IAB network);
a particular resource (e.g., Backhaul RLC channel) or a sequence of resources (e.g., a sequence of Backhaul RLC channels), established between the first NNF (e.g., an IAB-DU) and the second NNF (e.g., an IAB-donor).
a particular UE that is configured for RVQoE (e.g., RAN UE ID, gNB-CU UE F1AP ID, gNB-DU UE F1AP ID, QOE Reference, etc.);
a particular group of UEs that are configured for RVQoE (e.g., QoE Reference, Trace Recording Session Reference, etc.);
request/offer RVQoE measurements at a given periodicity (e.g., reporting periodicity).

In some embodiments, the FIRST MESSAGE sent by the first NNF to request RVQoE measurements from the second NNF and the SECOND MESSAGE sent by the second NNF to offer RVQoE measurements can also indicate one or more of the following:
one-shot or periodic reporting;
if periodic, a reporting period;
if one-shot, a time interval to which a report pertains (or should be excluded from such a report), which can be expressed as a starting time and/or an ending time, each of which can be expressed in absolute time (e.g., UTC) or relative to some network time event;
a total number or amount of RVQoE measurements;
a number of RVQoE measurements per message, e.g., one per message or each message including multiple RVQoE measurements pertaining to one or multiple UEs;
one or more UE-related triggering events or conditions, e.g., a gNB-CU-CP is requested to send RVQoE measurements for a particular UE to a gNB-DU or a gNB-CU-UP when the gNB-CU-CP has initiated handover preparation for the particular UE;
one or more RVQoE-related triggering events or conditions, such as any of the following:
   a single RVQOE metric has a value higher or lower than a threshold, between two thresholds, outside of two thresholds, etc.;
   a compound condition involving multiple RVQoE metrics, each having conditions or threshold(s), together with logic (e.g., AND, OR, etc.) linking the metric-specific conditions or thresholds. For example, a first RVQoE metric must have a value above a first threshold and a second RVQOE metric must have a value below a second threshold;
   availability of a particular RVQoE metric, e.g., the second NNF is requested to send RVQOE measurements any time a particular QoE metric is available at the second NNF, the second NNF is requested not to not send RVQoE measurements for a given UE unless one or more particular RVQoE metrics for the particular UE is available at the second NNF.
one or more RRC- or radio-related triggering events or conditions, such as:
   the second NNF has received RRC message(s) from UE(s) for which RVQoE measurements are configured and the RRC message(s) indicate the trigger of a mobility event(s). As a more specific example, the second NNF is requested to send RVQOE measurements for a particular UE after receiving a MeasurementReport RRC message indicating A3 event trigger based on radio-related measurements performed by the UE;
   send or receive RVQoE measurements that are associated with radio-related measurements (e.g., MDT measurements) collected at the first NNF or at the second NNF; or
   send or receive RVQoE measurements that are associated with radio-related measurements (e.g., MDT measurements) collected at the first NNF or at the second NNF, that have values above a threshold, below a threshold, between two thresholds, or outside of two thresholds.
one or more application layer triggering events or conditions, e.g., if the second NNF has received a session start indication associated with a particular UE;
one or more NNF resource-related triggering events or conditions, such as an indication of some lack of resources at the first NNF and/or at the second NNF. Specific examples include a control processing overload indication, a hardware failure indication, indication of insufficient user plane processing resources, etc. As a more specific example, the first NNF may indicate to the second NNF to keep sending or resume sending RVQoE measurements when the first NNF sends to the second NNF an indication of no-overload, such as a gNB-DU Overload Information set to “not-overloaded” within a F1AP GNB-DU STATUS INDICATION message. Alternately, the first NNF may indicate to the second NNF to stop or suspend sending RVQoE measurements when the first NNF sends to the second NNF an overload indication, such as a gNB-DU Overload Information set to “overloaded” within a F1AP GNB-DU STATUS INDICATION message.

In some embodiments, the FIRST MESSAGE sent by the first NNF to request RVQoE measurements from the second NNF can request to receive notification(s) from the second NNF that RVQoE measurements are available (or unavailable) at the second NNF. The request and subsequent notification(s) can be for particular RVQoE metric(s) or for all RVQoE measurements.

In some embodiments, the FIRST MESSAGE sent by the first NNF to request RVQoE measurements from the second NNF can request RVQoE assistance information, such as provided in the FIFTH MESSAGE described above and in more detail below. This request may be for particular type(s) of RVQoE assistance information.

In some embodiments, the SECOND MESSAGE sent by the second NNF to offer RVQoE measurements can also include a request to receive from the first NNF RVQOE associated feedback, such as provided in the SIXTH MESSAGE described above and in more detail below. This request may be for particular type(s) of RVQOE associated feedback.

After sending RVQoE measurement reports in one or more FOURTH MESSAGES, the second NNF may receive from the third NNF (e.g., in OAM) a SEVENTH MESSAGE including an indication to enable/disable subsequent sending of RVQoE measurement reports and/or configuration parameters to regulate subsequent sending of RVQoE measurement reports. Likewise, after receiving RVQoE measurement reports in one or more FOURTH MESSAGES, the first NNF may receive from the third NNF (e.g., in OAM) a SEVENTH MESSAGE including an indication to enable/disable subsequent receiving of RVQoE measurement reports and/or configuration parameters to regulate subsequent receiving of RVQoE measurement reports.

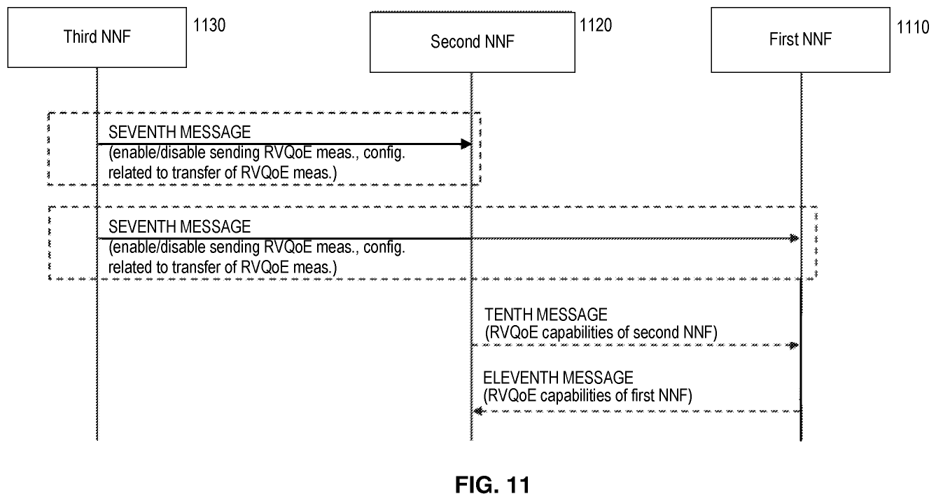

In some embodiments, the first and the second NNFs exchange capabilities with respect to RVQoE measurement reporting. FIG. 11 shows a signaling diagram between a first NNF (1110), a second NNF (1120), and a third NNF (1130), according to these embodiments. As shown in FIG. 11, the first NNF (e.g., gNB-DU) can send to the second NNF (e.g., gNB-CU-CP) a TENTH MESSAGE including RVQoE related capability information of the first NNF, and the second NNF (e.g., gNB-CU-CP) can send to the first NNF (e.g., gNB-DU) an ELEVENTH MESSAGE including RVQoE related capability information of the second NNF.

In some embodiments, the TENTH MESSAGE and/or the ELEVENTH MESSAGE can be used to exchange capability information at establishment of a signaling interface between the first NNF and the second NNF. For example, the TENTH MESSAGE can be an F1 SETUP REQUEST F1AP message and the ELEVENTH MESSAGE can be an F1 SETUP RESPONSE F1AP message, or vice versa.

In other embodiments, the TENTH MESSAGE and/or the ELEVENTH MESSAGE can be used to exchange updated capability information, after establishment of the signaling interface between the first and second NNFs. For example, the TENTH MESSAGE can be a GNB-DU CONFIGURATION UPDATE F1AP message and the ELEVENTH MESSAGE can be a GNB-CU CONFIGURATION UPDATE F1AP message, or vice versa.

In other embodiments, the information included in the TENTH MESSAGE and/or the ELEVENTH MESSAGE can be exchanged using XnAP signaling, during Xn interface setup or during any of the procedures for Dual Connectivity, specified in 3GPP TS 38.423 (v17.0.0) section 8.3. In such embodiments, the first and second NNFs may be a gNB-CU/gNB-CU-CP and a gNB-DU or two gNB-CUs/gNB-CU-CPs/gNBs that have an established Xn interface and that are, optionally, serving the same UE.

In some embodiments, the SEVENTH MESSAGE discussed above can include a configuration related to sending or requesting of RVQOE measurements. For example, the SEVENTH MESSAGE can include a configuration that the second NNF can use to determine conditions for sending RVQoE measurements to the first NNF (e.g., as shown in FIGS. 7-8). As another example, the SEVENTH MESSAGE can include a configuration that the first NNF can use to determine conditions for requesting or accepting RVQoE measurements provided by the first NNF. In the example shown in FIG. 11, the SEVENTH MESSAGES also include indications to enable/disable the sending of RVQoE measurements.

In various embodiments, one or more of the SEVENTH MESSAGE, the TENTH MESSAGE, and the ELEVENTH MESSAGE mentioned above can precede the RVQoE measurement coordination process described above. This is illustrated by operations 300 in FIGS. 7-9.

In various embodiments, the RVQoE related configuration included in the SEVENTH MESSAGE can include any of the following information:
enable/disable sending of RVQoE measurement reports from the second NNF (which also may be separate from the configuration, as shown in FIG. 11);
enable/disable reception of RVQoE measurement reports at the first NNF (which also may be separate from the configuration, as shown in FIG. 11);
one or more RVQOE metrics configured to be sent/received or to be used by the first/second NNF
one or more RVQoE values configured to be sent/received or to be used by the first/second NNF
reporting period for sending/receiving RVQoE metrics and/or RVQoE values
conditions (e.g., timers, thresholds or events) for sending/refraining from sending the RVQOE measurements from the second NNF
conditions (e.g., timers, thresholds or events) for receiving/using or refraining from receiving/using RVQoE measurements by the first NNF

In various embodiments, the RVQOE capabilities included in the TENTH MESSAGE and the ELEVENTH message can include indications of one or more of the following:
support for RVQoE measurements in general;
support (e.g., by first NNF) for subscribing to RVQoE measurements and dynamically modifying the subscription during an application measurement session (e.g., modifying frequency of reporting or any other subscription parameter);
support (e.g., by second NNF) for providing the RVQoE measurements based on the subscription, where the subscription can be static or dynamically modified during one application measurement session);
support for RVQoE metrics and/or support for RVQoE values;
support for alignment of RVQoE measurements with radio-related measurements and/or other radio-related information;
support for one or more specific RVQoE metrics (e.g., buffer level, playout delay for media start-up, etc.);
support for one or more specific RVQoE values (e.g., MOS for voice, MOS for video); In some of these embodiments, an indication of support can be an indication of a lack of support.

In some embodiments, the second NNF determines to send RVQoE measurements to the first NNF based on receiving the FIRST MESSAGE including a request from the first NNF (e.g., a gNB-DU) to receive RVQOE measurements. FIGS. 7 and 9 show examples of these embodiments. In other embodiments, In some embodiments, the second NNF determines to send RVQOE measurements to the first NNF based on receiving the SEVENTH MESSAGE from the third NNF (e.g., in CN or OAM) that includes indication to enable/disable sending of RVQoE measurements, a request/indication to start/stop/pause/resume/modify sending of RVQoE measurements to the first NNF, etc. FIG. 8 shows an example of these embodiments.

As mentioned above, the FOURTH MESSAGE including RVQoE measurements can be sent by the second NNF to the first NNF using UE-associated or non-UE-associated signaling. Conventional solutions (e.g., FIG. 6) only use UE-associated signaling for sending RVQoE measurements. However, even if the FOURTH MESSAGE is sent via UE-associated signaling, it includes various information not included in conventional approaches, which facilitates the coordination between first and second NNFs according to various embodiments of the present disclosure.

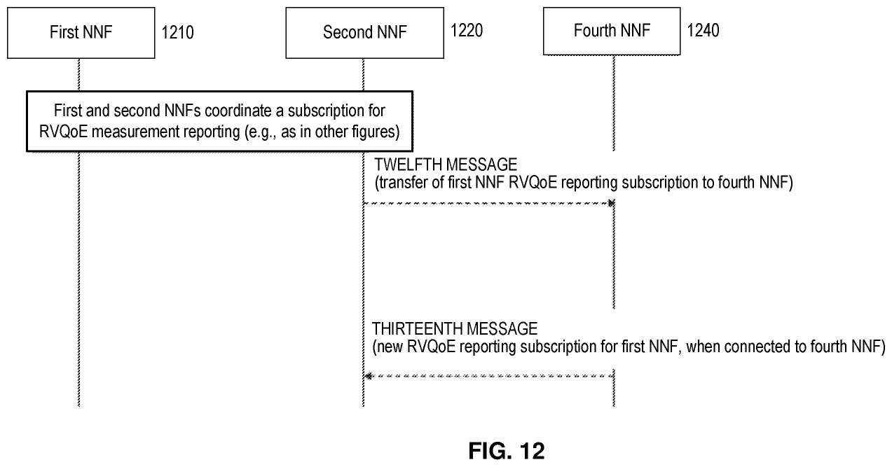

In some embodiments, the first NNF (e.g., a gNB-DU, IAB-DU) can be mobile. In such embodiments, it can be handed over from the second NNF to a fourth NNF (e.g., a CU or a CU-CP or a donor CU/CU-CP or a gNB). In that case, the second NNF may inform the fourth NNF about the configuration of the RVQoE reporting subscription and/or about the capabilities of the first node related to the RVQoE reporting subscription. FIG. 12 shows a signaling diagram between the first NNF (1210), the second NNF (1220), and the fourth NNF (1240) according to these embodiments.

As shown in FIG. 12, the second NNF may send to the fourth NNF the RVQoE reporting subscription that it previously negotiated with the first NNF. In the example shown in FIG. 12, this information can be conveyed in a TWELFTH MESSAGE, which may be newly defined. Alternately, this information can be conveyed by a newly defined IE included in an XnAP or NGAP message related to handover of the first NNF. In various embodiments, the TWELFTH MESSAGE can include one or more of the following:
information about the current subscription for RVQoE reporting;
information about the capabilities of the first NNF related to subscription for RVQoE reporting (from the ELEVENTH MESSAGE); and
information about subscription to RVQOE assistance information (from the FIFTH MESSAGE) and/or to RVQoE associated feedback (from the THIRD MESSAGE).

The fourth NNF may respond with a THIRTEENTH MESSAGE, which may be newly defined. Alternately, the fourth NNF can respond with a newly defined IE included in an XnAP or NGAP message related to handover of the first NNF. In various embodiments, the THIRTEENTH MESSAGE can include one or more of the following:
an acknowledgement or confirmation of the TWELFTH MESSAGE; and
New configuration(s). For instance, the fourth NNF may decide to update the configuration(s) and convey them to the first NNF, indirectly, via the second NNF, during handover preparation. The new configuration(s) may become valid, e.g., from the moment the first NNF has connected to the fourth NNF.

In some embodiments, the first and second NNFs can be respective target and source nodes (e.g., gNBs, gNB-CUs, gNB-CU-CPs) in a UE handover. According to these embodiments, the source node sends RVQoE measurement results to the target node. In some of these embodiments, the first NNF (which became the target node) previously sent a proactive request to the second NNF (which became the source node) for RVQOE measurement results in conjunction with possible subsequent handover procedures between first and second NNFs.

When the second NNF subsequently initiates a handover of a UE to the first NNF, the second NNF includes RVQoE measurement results originating from that UE, in accordance with the request in a HANDOVER REQUEST XnAP message sent to the first NNF. The first NNF, in its new role as target node, may take the received RVQoE measurement results into account when determining parts of the UE configuration it includes in the HandoverCommand that it includes in the HANDOVER REQUEST ACKNOWLEDGE XnAP message sent to the second NNF. Alternately, the first NNF may take the received RVQoE measurement results into account when determining scheduling priorities when the UE accesses the target cell controlled by the first NNF.

As one example, the first NNF can send a proactive request to the second NNF in conjunction with establishment of an Xn interface between the first and second NNFs, e.g., in an XN SETUP REQUEST XnAP message or in an XN SETUP RESPONSE XnAP message. As another example, the first NNF can send a proactive request to the second NNF in an NG-RAN NODE CONFIGURATION UPDATE XnAP message or in an NG-RAN NODE CONFIGURATION UPDATE ACKNOWLEDGE XnAP message.

In some embodiments, the second NNF (acting as the source node) can send RVQoE measurement results, originating from the UE being handed over, to the first NNF (acting as the target node) in a HANDOVER REQUEST XnAP message even without having received a prior request from the first NNF. The first NNF may use the received RVQoE measurement results as described above.

When RVQoE-related signaling between the first NNF and the second NNF is non-UE associated, the initial signaling for request for, or offer of, RVQoE measurement results may be sent in conjunction with establishment of an interface (e.g., Xn or F1) between the first and second NNFs. As one option, the request and/or offer may be piggybacked on existing messages used for interface establishment, e.g., XN SETUP REQUEST message, or XN SETUP RESPONSE message, F1 SETUP REQUEST message, or F1 SETUP RESPONSE message.

An additional possibility is that the request and/or offer may be included in an NG-RAN NODE CONFIGURATION N UPDATE XnAP message or an NG-RAN NODE CONFIGURATION UPDATE ACKNOWLEDGE XnAP message (in case of an Xn interface). Another possibility is that the request is included in a GNB-DU CONFIGURATION UPDATE F1AP message and/or the offer is included in a GNB-CU CONFIGURATION UPDATE F1AP message (in case of an F1 interface).

The subsequent signaling involving transfer of RVQoE measurement results, RVQoE assistance information and/or RVQoE associated feedback information may be UE associated signaling.

The various enumerated messages discussed above can occur in various orders. Likewise, there can be more than one instance a particular message and/or differently numbered messages can be into a single message. The following are some illustrative but non-limiting examples:
the second NNF can receive a SEVENTH MESSAGE from a CN node or an OAM node before or after the RVQOE measurements become available at the second NNF;
the first NNF can send a FIRST MESSAGE before or after RVQoE measurements are available at the second NNF;
the second NNF can send a SECOND MESSAGE before or after RVQoE measurements are available at the second NNF;
the first NNF can send more than one FIRST MESSAGE to the second NNF, e.g., a first to request initiating the sending of RVQoE measurements is initiated and a subsequent second to request a pause in the sending;
the first NNF can receive a FOURTH MESSAGE comprising RVQoE measurements together with a FIFTH MESSAGE comprising RVQoE assistance information;
the first NNF can receive a FOURTH MESSAGE comprising RVQoE measurements together with a FIFTH MESSAGE requesting RVQoE assistance information;
the first NNF can receive a FOURTH MESSAGE comprising RVQoE measurements together with a THIRD MESSAGE requesting RVQoE associated feedback.

As a specific example, a gNB-CU-CP can send to a gNB-DU the RVQoE metrics for a UE (FOURTH MESSAGE) and, together with those, a request to the gNB-DU to receive RVQoE associated feedback (THIRD MESSAGE). This scenario can occur when the FOURTH MESSAGE includes RVQoE measurements obtained/derived at the gNB-CU-CP for a UE after the UE has completed a handover towards a (target) cell served by the gNB-CU-CP and under the control of the gNB-DU, and the gNB-CU-CP wants to collect from the gNB-DU some performance indicator for the UE in the target cell.

In some embodiments, the FIRST MESSAGE can be realized as a new F1AP message such as a RAN VISIBLE QOE REQUEST, a QOE TRANSFER REQUEST, a QOE INFORMATION TRANSFER REQUEST, etc. Alternately, the FIRST MESSAGE can be realized as an XnAP message for Xn interface management (e.g., Xn SETUP REQUEST, XN SETUP RESPONSE) or for dual connectivity (e.g., XnAP S-NODE ADDITION REQUEST).

In some embodiments, the SECOND MESSAGE can be realized as a new F1AP message such as a RAN VISIBLE QOE NOTIFICATION, QOE INFORMATION TRANSFER NOTIFICATION, etc. Alternately, the SECOND MESSAGE can be realized as an XnAP message for Xn interface management (e.g., Xn SETUP REQUEST, XN SETUP RESPONSE) or for dual connectivity (e.g., an XnAP S-NODE ADDITION REQUEST).

In some embodiments, the EIGHT MESSAGE can be realized as a (new) RAN VISIBLE QOE INFORMATION RESPONSE or a (new) QOE INFORMATION RESPONSE message (e.g., F1AP messages) or alike, or a QOE INFORMATION FAILURE or an XnAP message for Xn interface management (e.g., Xn SETUP REQUEST, XN SETUP RESPONSE), or dual connectivity (e.g., an XnAP S-NODE ADDITION REQUEST).

In some embodiments, the SIXTH MESSAGE can be realized as a new F1AP message such as a RAN VISIBLE QOE INFORMATION FEEDBACK message, or a QOE INFORMATION FEEDBACK message, or a QOE INFORMATION TRANSFER FEEDBACK or alike.

As a specific example, the FIRST MESSAGE can be realized as an F1AP QOE TRANFER REQUEST message and the FOURTH MESSAGE can be realized as an F1AP QOE TRANSFER UPDATE message, with exemplary contents shown in respective Tables 3-4 below. In this example both messages are non-UE associated. In the F1AP QOE TRANFER REQUEST message, the gNB-DU requests the gNB-CU RVQOE measurements associated to certain characteristics, such as a certain DRB ID, or a certain QoS Flow Identifier. In the F1AP QOE TRANSFER UPDATE message, the gNB-DU receives from the gNB-CU the requested RVQoE measurements associated to certain characteristics, such as a certain DRB ID, or a certain QoS Flow Identifier.

TABLE 3

| IE/Group Name | Pres. | Range | IE type/ref. | Semantics description |
|---|---|---|---|---|
| Message Type | M | | 9.3.1.1 | |
| Transaction ID | M | | 9.3.1.23 | |
| gNB-DU | M | | INTEGER | Allocated by gNB-DU |
| Measurement ID | | | (1 . . . 4095, . . . ) | |
| gNB-CU | C- | | INTEGER | Allocated by gNB-CU |
| Measurement ID | ifRegistrationRequestStoporAdd | | (1 . . . 4095, . . . ) | |
| Registration | M | | ENUMERATED | Type of request for which |
| Request | | | (start, stop, | the resource status is |
| | | | add, . . . ) | required. |
| Report | C- | | BIT STRING | Each position in the bitmap |
| Characteristics | ifRegistrationRequestStart | | (SIZE(32)) | indicates measurement object |
| | | | | the gNB-CU is requested to |
| | | | | report. First Bit = per PDU |
| | | | | Session reporting, Second |
| | | | | Bit = per DRB reporting, |
| | | | | Third Bit = per QoS flow |
| | | | | reporting, other bits shall be |
| | | | | ignored by the gNB-CU. |
| PDU Session To | | 0 . . . 1 | | PDU Session list to which |
| Report List | | | | the request applies. |
| >PDU Session To | | 1 . . . <maxPDUSessionID> | | |
| Report Item | | | | |
| >>PDU Session | M | | INTEGER | |
| ID | | | (0 . . . 255) | |
| DRB To Report | | 0 . . . 1 | | DRB ID list to which the |
| List | | | | request applies. |
| >DRB To Report | | 1 . . . <maxDRBID> | | |
| Item | | | | |
| >>DRB ID | M | | INTEGER (1 . . . | |
| | | | 32, . . . ) | |
| QoS Flow | | 0 . . . 1 | | QoS Flow identifier list to |
| Identifier To | | | | which the request applies. |
| Report List | | | | |
| >QoS Flow | | 1 . . . <maxQoSFlowID> | | |
| Identifier To | | | | |
| Report Item | | | | |
| >>QoS Flow | M | | INTEGER (0 . . . 63) | |
| Identifier | | | | |

TABLE 4

| IE/Group Name | Pres. | Range | IE type/ref. | Semantics description |
|---|---|---|---|---|
| Message Type | M | | 9.3.1.1 | |
| Transaction ID | M | | 9.3.1.23 | |
| gNB-DU | M | | INTEGER | Allocated by gNB-DU |
| Measurement ID | | | (1 . . . 4095, . . . ) | |
| gNB-CU | C- | | INTEGER | Allocated by gNB-CU |
| Measurement ID | ifRegistrationRequestStoporAdd | | (1 . . . 4095, . . . ) | |
| PDU Session | | 0 . . . 1 | | PDU Session list to which |
| Results | | | | the request applies. |
| >PDU Session | | 1 . . . <maxPDUSessionID> | | |
| Results Item | | | | |
| >>PDU Session ID | M | | INTEGER | |
| | | | (0 . . . 255) | |
| >>QoE Metrics | O | | 9.3.1.260 | |
| DRB Results | | 0 . . . 1 | | DRB ID list to which the |
| | | | | request applies. |
| >DRB Results | | | | |
| Item | | | | |
| >>QoE Metrics | O | | 9.3.1.260 | |
| QoS Flow Results | | 0 . . . 1 | | QoS Flow identifier list to |
| | | | | which the request applies. |
| >QoS Flow | | 1 . . . <maxQoSFlowID> | | |
| Results Item | | | | |
| >>QoS Flow | M | | INTEGER | |
| Result Item | | | (0 . . . 63) | |
| >>QoE Metrics | O | | 9.3.1.260 | |

The following values are used in Tables 3-4:
maxPDUSessionID: Maximum no. of PDU Session ID, the maximum value is 256.
maxDRBID: Maximum no. of DRB Session ID, the maximum value is 32.
maxQoSFlowID: Maximum no. of QoS Flow Identifier, the maximum value is 64.

As another specific example, the FIRST MESSAGE can be realized as an F1AP QOE INFORMATION TRANFER REQUEST message, with exemplary contents shown in Table 5 below. In this example, QOE INFORMATION TRANFER REQUEST message is UE associated. In this message, the gNB-DU requests from the gNB-CU RVQOE measurements associated with certain characteristics, such as a particular DRB ID, a particular QoS Flow Identifier, etc. In the responsive F1AP QOE TRANSFER UPDATE message (shown in Table 4 above), the gNB-DU receives from the gNB-CU the requested RVQoE measurements associated with the indicated characteristics. The values listed above for Tables 3-4 are also used in the message in Table 5.

TABLE 5

| IE/Group Name | Pres. | Range | IE type/ref. | Semantics description |
|---|---|---|---|---|
| Message Type | M | | 9.3.1.1 | |
| gNB-CU UE F1AP | M | | 9.3.1.4 | |
| ID | | | | |
| gNB-DU UE F1AP | M | | 9.3.1.5 | |
| ID | | | | |
| Registration | M | | ENUMERATED | Type of request for which |
| Request | | | (start, stop, | the resource status is |
| | | | add, . . . ) | required. |
| Report | C- | | BIT STRING | Each position in the bitmap |
| Characteristics | ifRegistrationRequestStart | | (SIZE(32)) | indicates measurement object |
| | | | | the gNB-CU is requested to |
| | | | | report. First Bit = per PDU |
| | | | | Session reporting, Second |
| | | | | Bit = per DRB reporting, |
| | | | | Third Bit = per QoS flow |
| | | | | reporting. Other bits shall be |
| | | | | ignored by the gNB-CU. |
| PDU Session To | | 0 . . . 1 | | PDU Session list to which |
| Report List | | | | the request applies. |
| >PDU Session To | | 1 . . . <maxPDUSessionID> | | |
| Report Item | | | | |
| >>PDU Session | M | | INTEGER | |
| ID | | | (0 . . . 255) | |
| DRB To Report | | 0 . . . 1 | | DRB ID list to which the |
| List | | | | request applies. |
| >DRB To Report | | 1 . . . <maxDRBID> | | |
| Item | | | | |
| >>DRB ID | M | | INTEGER (1 . . . | |
| | | | 32, . . . ) | |
| QoS Flow | | 0 . . . 1 | | QoS Flow identifier list to |
| Identifier To | | | | which the request applies. |
| Report List | | | | |
| >QoS Flow | | 1 . . . <maxQoSFlowID> | | |
| Identifier To | | | | |
| Report Item | | | | |
| >>QoS Flow | M | | INTEGER | |
| Identifier | | | (0 . . . 63) | |

As another specific example, the FIRST MESSAGE can be realized as an F1AP QOE INFORMATION TRANSFER INDICATION message, with exemplary contents shown in Table 6 below. In this example, the QOE INFORMATION TRANSFER INDICATION message is UE associated. In the QOE INFORMATION TRANSFER INDICATION message, the gNB-DU sends to the gNB-CU an indication that the gNB-CU should start or step sending RAN Visible QoE measurements for a particular UE to the gNB-DU.

TABLE 6

| | | | | |
|---|---|---|---|---|
| IE/Group Name | Pres. | Range | IE type/ref. | Semantics description |

| | | | |
|---|---|---|---|
| Message Type | M | 9.3.1.1 | |
| gNB-CU UE F1AP ID | M | 9.3.1.4 | |
| gNB-DU UE F1AP ID | M | 9.3.1.5 | |
| RAN Visible QoE | M | ENUMERATED | Indicates whether gNB-CU |
| Measurements | | (start, stop, . . . ) | can start sending RAN Visible |
| Transfer | | | QoE measurements to the |
| | | | gNB-DU or the gNB-CU |
| | | | should stop sending RAN |
| | | | Visible QoE measurements to |
| | | | the gNB-DU. |

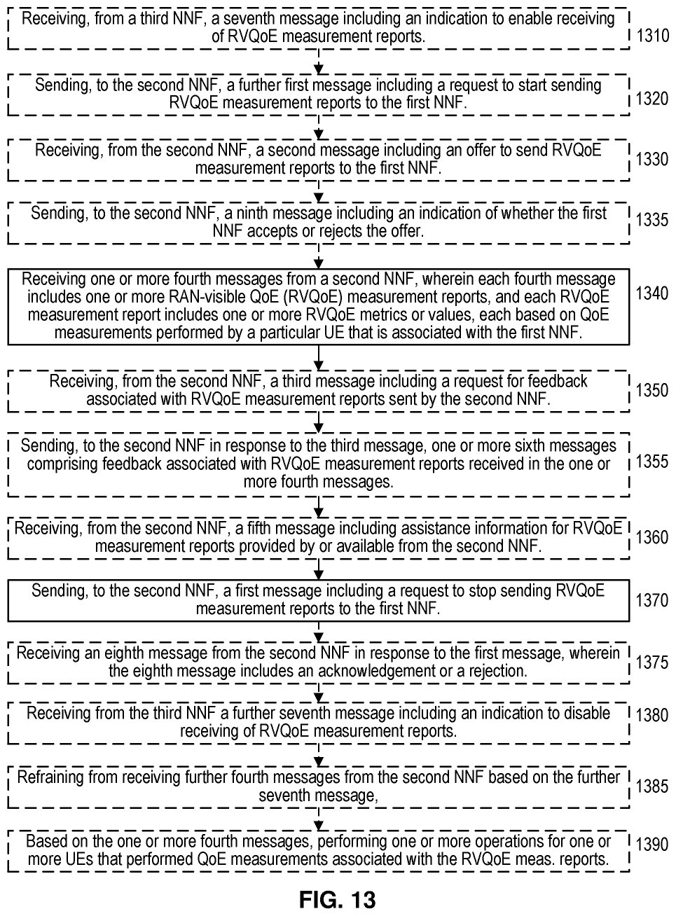

Various features of the embodiments described above correspond to various operations illustrated in FIGS. 13-15, which show exemplary methods (e.g., procedures) for first NNF, a second NNF, and a fourth NNF, respectively. In other words, various features of the operations described below correspond to various embodiments described above. Furthermore, the exemplary methods shown in FIGS. 13-15 can be used cooperatively to provide various benefits, advantages, and/or solutions to problems described herein. Although FIGS. 13-15 show specific blocks in particular orders, the operations of the exemplary methods can be performed in different orders than shown and can be combined and/or divided into blocks having different functionality than shown. Optional blocks or operations are indicated by dashed lines.

In particular, FIG. 13 shows an exemplary method (e.g., procedure) for distributing QoE measurements performed by UEs in a RAN, according to various embodiments of the present disclosure. The exemplary method can be performed by a first NNF (e.g., gNB, gNB-DU, etc.) such as described elsewhere herein. For example, different embodiments of the exemplary method can be performed by first NNF (710), gNB-DU (1010), first NNF (1110), and first NNF (1210) mentioned above in relation to FIGS. 7-12.

The exemplary method includes the operations of block 1340, where the first NNF can receive one or more fourth messages from a second NNF of the RAN. Each fourth message includes one or more RVQoE measurement reports and each RVQoE measurement report includes one or more RVQOE metrics or values, with each RVQoE metric or value based on QoE measurements performed by a particular UE that is associated with the first NNF. The exemplary method also includes the operations of block 1370, where the first NNF can subsequently send to the second NNF a first message including a request to stop sending RVQoE measurement reports to the first NNF.

In some embodiments, the first NNF is a gNB-DU, the second NNF is a gNB-CU or a part thereof, and the first message is sent via an F1AP interface between the first and second NNFs. In other embodiments, the first NNF is a first RAN node, the second NNF is a second RAN node, and the first message is sent via an XnAP interface between the first and second NNFs.

In some embodiments, the exemplary method can also include the operations of block 1390, where based on the one or more fourth messages, the first NNF (e.g., gNB-DU) can perform one or more of the following for one or more the UEs that performed QoE measurements associated with the RVQoE measurement reports: scheduling data transmission and/or reception, and selection of a modulation and coding scheme for data transmission and/or reception.

In some embodiments, the exemplary method can also include the operations of block 1320, where the first NNF can send, to the second NNF, a further first message including a request to start sending RVQoE measurement reports to the first NNF. The one or more fourth messages are received in response to the further first message.

In some of these embodiments, the further first message indicates one or more of the following:
one-shot or periodic reporting;
if periodic reporting, a reporting period (i.e., how often to send a report);
if one-shot, a time interval to which a report pertains or which should be excluded from a report;
a total number or amount of RVQoE measurements (i.e., to be reported);
a number of RVQoE measurements per fourth message;
one or more UE-related triggering events or conditions;
one or more RVQoE-related triggering events or conditions;
one or more RRC- or radio-related triggering events or conditions:
one or more UE application layer triggering events or conditions
one or more NNF resource-related triggering events or conditions

In some of these embodiments, the first message and the further first message include same identifiers of one or more of the following: UE, UE group, QoE reference, trace recording session, and application layer measurement configuration. In some of these embodiments, the further first message indicates RVQOE measurements from all UEs that are configured for RVQoE measurements and associated with or served by one of the following: the first NNF, or the second NNF. In some of these embodiments, the further first message indicates RVQoE measurements associated with one or more of the following: network slice, cell, beam, data radio bearer, communication direction between a UE and an NNF, communication path through the RAN, protocol type, protocol addresses and/or port numbers, and a reporting periodicity.

In other embodiments, the exemplary method can also include the operations of blocks 1330-1335, where the first NNF can receive from the second NNF a second message including an offer to send RVQoE measurement reports to the first NNF, and send to the second NNF a ninth message including an indication of whether the first NNF accepts or rejects the offer. Moreover, the one or more fourth messages are received in response to the ninth message indicating that the first NNF accepts the offer.

In some embodiments, the exemplary method can also include the operations of blocks 1350-1355, where the first NNF can receive from the second NNF a third message including a request for feedback associated with RVQoE measurement reports sent by the second NNF, and send to the second NNF in response to the third message, one or more sixth messages comprising feedback associated with RVQoE measurement reports received in the one or more fourth messages.

In some of these embodiments, each sixth message is associated with a corresponding fourth message and includes indication of one or more of the following:
whether the one or more RVQOE metrics or values in the associated fourth message were used by the first NNF;
one or more operations performed by the first NNF based on the one or more RVQoE metrics or values in the associated fourth message; and
one or more effects on UEs of operations performed by the first NNF based on the one or more RVQoE metrics or values in the associated fourth message.

In some embodiments, the exemplary method can also include the operations of block 1360, where the first NNF can receive from the second NNF a fifth message including assistance information for RVQoE measurement reports provided by or available from the second NNF. In some of these embodiments, the assistance information includes identifiers of one or more of the following associated with RVQoE measurement reports received in the one or more fourth messages: UE, UE group, QoE reference, trace recording session, application session PDU session, application layer measurement configuration, network slice, cell, beam, data radio bearer, communication direction, protocol type, and protocol addresses and/or port numbers.

In some of these embodiments, the fifth message is received with one of the fourth messages in a single message.

In some embodiments, the exemplary method can also include the operations of block 1375, where the first NNF can receive an eighth message from the second NNF in response to the first message (e.g., in block 1370). The eighth message includes one or more of the following:
an acknowledgement indicating that the second NNF will stop sending RVQoE measurement reports to the first NNF;
a rejection indicating that the second NNF will continue sending RVQoE measurement reports to the first NNF; and
when the rejection is included, an indication of a reason for the rejection.

In some embodiments, the exemplary method can also include the operations of block 1310, where the first NNF can receive from a third NNF a seventh message including an indication to enable receiving of RVQoE measurement reports. In such case, the one or more fourth messages are received responsive to the seventh message. In some of these embodiments, the exemplary method can also include the operations of block 1380, where after receiving the one or more fourth messages, the first NNF can receive from the third NNF a further seventh message including an indication to disable receiving of RVQoE measurement reports. In such case, the exemplary method also includes the operations of block 1385, where the first NNF refrains from receiving further fourth messages from the second NNF based on the further seventh message.

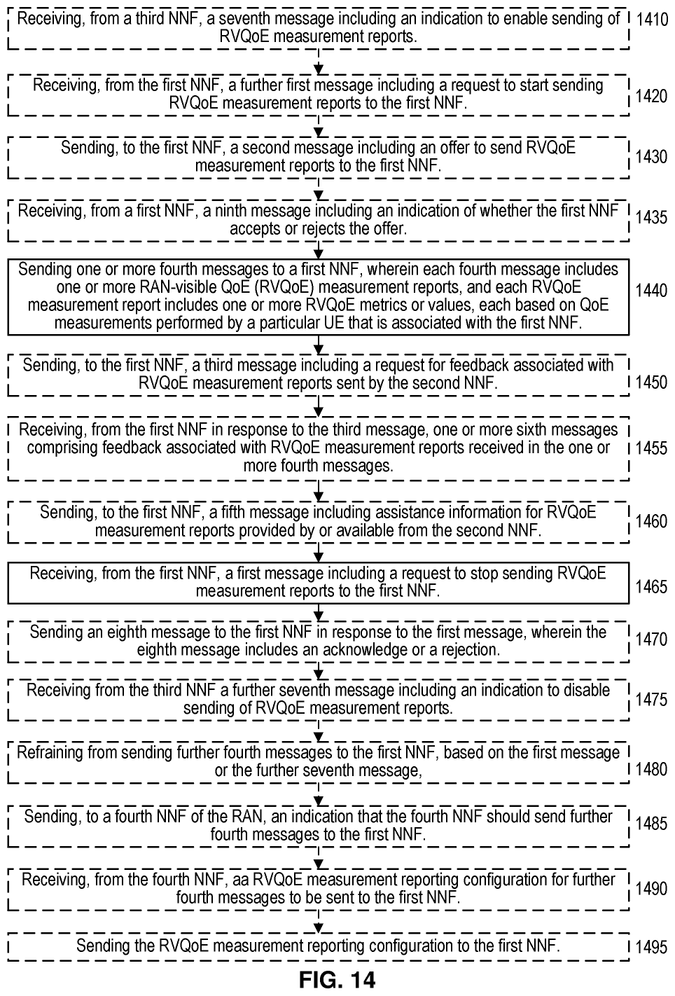

In addition, FIG. 14 shows another exemplary method (e.g., procedure) for distributing QoE measurements performed by UEs in a RAN, according to various embodiments of the present disclosure. This exemplary method can be performed by a second NNF (e.g., gNB, gNB-CU, gNB-CU-CP, etc.) such as described elsewhere herein. For example, different embodiments of the exemplary method can be performed by second NNF (720), gNB-CU-CP (1020), second NNF (1120), and second NNF (1220) mentioned above in relation to FIGS. 7-12.

The exemplary method includes the operations of block 1440, where the second NNF can send one or more fourth messages to a first NNF of the RAN. Each fourth message includes one or more RVQoE measurement reports, and each RVQoE measurement report includes one or more RVQOE metrics or values, with each RVQoE metric or value based on QoE measurements performed by a particular UE that is associated with the first NNF. The exemplary method also includes the operations of block 1465, where the second NNF can subsequently receive from the first NNF a first message including a request to stop sending RVQoE measurement reports to the first NNF.

In some embodiments, the first NNF is a gNB-DU, the second NNF is a gNB-CU or a part thereof, and the first message is sent via an F1AP interface between the first and second NNFs. In other embodiments, the first NNF is a first RAN node, the second NNF is a second RAN node, and the first message is sent via an XnAP interface between the first and second NNFs.

In some embodiments, the exemplary method can also include the operations of block 1480, where based on the first message, the second NNF can refrain from sending the first NNF further fourth messages including RVQoE measurement reports.

In some embodiments, the exemplary method can also include the operations of block 1420, where the second NNF can receive from the first NNF a further first message including a request to start sending RVQoE measurement reports to the first NNF. The one or more fourth messages are sent in response to the further first message. In various embodiments, the further first message can have any of the same content described above in relation to FIG. 13.

In some embodiments, the exemplary method can also include the operations of blocks 1430-1435, where the second NNF can send to the first NNF a second message including an offer to send RVQoE measurement reports to the first NNF, and receive from the first NNF a ninth message including an indication of whether the first NNF accepts or rejects the offer. In such case, the one or more fourth messages are sent (e.g., in block 1440) in response to the ninth message indicating that the first NNF accepts the offer.

In some embodiments, the exemplary method can also include the operations of block 1460, where the second NNF can send to the first NNF a fifth message including assistance information for RVQoE measurement reports provided by or available from the second NNF. In various embodiments, the assistance information can include any of the same content described above in relation to FIG. 13. In some embodiments, the fifth message is sent with one of the fourth messages in a single message.

In some embodiments, the exemplary method can also include the operations of block 1470, where the second NNF can send an eighth message to the first NNF in response to the first message. The eighth message can include any of the same content described above in relation to FIG. 13.

In some embodiments, the exemplary method can also include the operations of blocks 1450-1455, where the second NNF can send to the first NNF a third message including a request for feedback associated with RVQoE measurement reports sent by the second NNF; and receive from the second NNF in response to the third message, one or more sixth messages comprising feedback associated with RVQoE measurement reports received in the one or more fourth messages. In some of these embodiments, each sixth message is associated with a corresponding fourth message and can include any of the same content described above in relation to FIG. 13.

In some embodiments, the exemplary method can also include the operations of block 1485, where the second NNF can send, to a fourth NNF of the RAN, an indication that the fourth NNF should send further fourth messages to the first NNF. In some of these embodiments, the exemplary method can also include the operations of blocks 1490-1495, where the second NNF can receive from the fourth NNF an RVQoE measurement reporting configuration for further fourth messages to be sent to the first NNF, and send the RVQoE measurement reporting configuration to the first NNF. In some variants, sending the indication to the fourth NNF in block 1485 can be responsive to initiating a handover of the first NNF from the second NNF to the fourth NNF, such as described in more detail above.

In some embodiments, the exemplary method can also include the operations of block 1410, where the second NNF can receive from a third NNF a seventh message including an indication to enable sending of RVQoE measurement reports. In such case, the one or more fourth messages are sent responsive to the seventh message. In some of these embodiments, the exemplary method can also include the operations of block 1475, where after sending the one or more fourth messages, the second NNF can receive from the third NNF a further seventh message including an indication to disable sending of RVQoE measurement reports. In such case, the refraining in operation 1480 can be based on the further seventh message received in block 1475, rather than the first message received in block 1465.

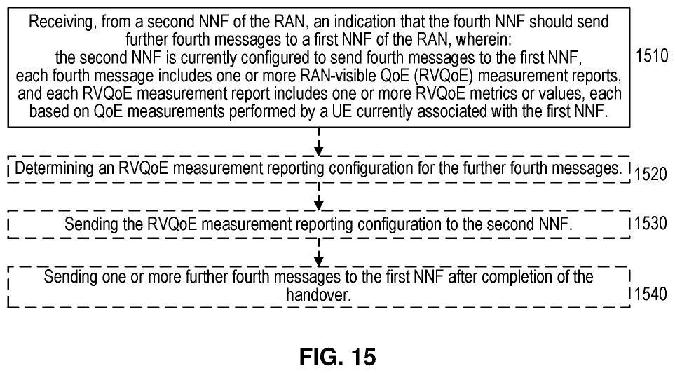

In addition, FIG. 15 shows an exemplary method (e.g., procedure) for a fourth NNF of a RAN to manage distribution within the RAN of QoE measurements by UEs, according to various embodiments of the present disclosure. The exemplary method can be performed by a fourth NNF (e.g., gNB, gNB-CU, gNB-CU-CP, etc.) such as described elsewhere herein. For example, different embodiments of the exemplary method can be performed by fourth NNF (1240) mentioned above in relation to FIG. 12.

The exemplary method can include the operations of block 1510, where the fourth NNF can receive, from a second NNF of the RAN, an indication that the fourth NNF should send further fourth messages to a first NNF of the RAN. The second NNF is currently configured to send fourth messages to the first NNF and each fourth message includes one or more RAN-visible QoE (RVQoE) measurement reports. Each RVQoE measurement report includes one or more RVQoE metrics or values, each based on QoE measurements performed by a UE that is currently associated with the first NNF.

In some embodiments, the exemplary method can also include the operations of blocks 1520-1530, where the fourth NNF can determine an RVQoE measurement reporting configuration for the further fourth messages and send the RVQoE measurement reporting configuration to the second NNF.

In some embodiments, the indication is received from the second NNF in conjunction with a handover of the first NNF from the second NNF to the fourth NNF. In some of these embodiments, the exemplary method can also include the operations of block 1540, where the fourth NNF can send one or more further fourth messages to the first NNF after completion of the handover.

In some embodiments, the first NNF is an integrated access backhaul (IAB) node comprising a mobile termination (MT) portion and a distributed unit (DU) portion. In some of these embodiments, the first NNF may be a mobile IAB node.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

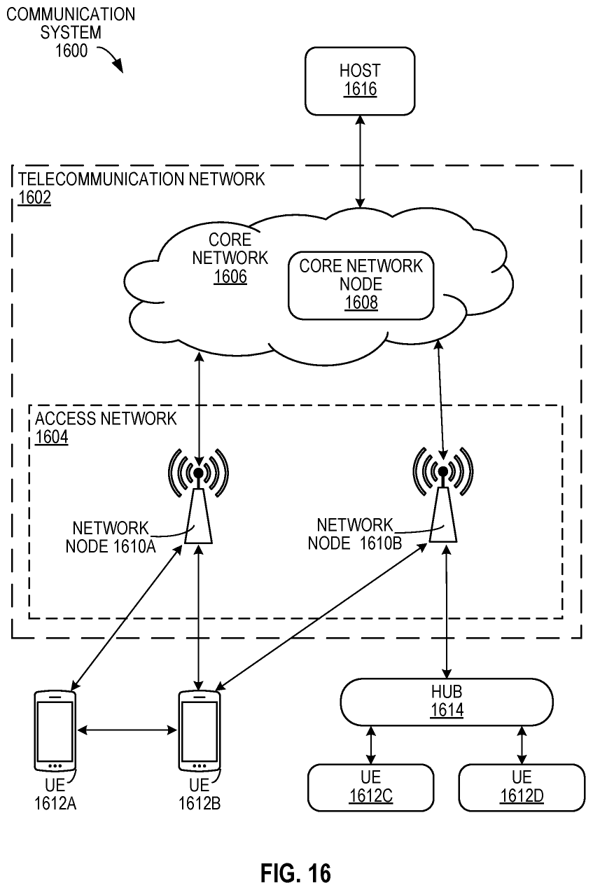

FIG. 16 shows an example of a communication system 1600 in accordance with some embodiments. In this example, communication system 1600 includes a telecommunication network 1602 that includes an access network 1604 (e.g., RAN), and a core network 1606, which includes one or more core network nodes 1608. Access network 1604 includes one or more access network nodes, such as network nodes 1610a-b (one or more of which may be generally referred to as network nodes 1610), or any other similar 3GPP access node or non-3GPP access point. Network nodes 1610 facilitate direct or indirect connection of UEs, such as by connecting UEs 1612a-d (one or more of which may be generally referred to as UEs 1612) to core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1600 may include any number of wired or wireless networks, network nodes, UEs, and/or any other components or systems that may facilitate or participate in the communication of data and/or signals whether via wired or wireless connections. Communication system 1600 may include and/or interface with any type of communication, telecommunication, data, cellular, radio network, and/or other similar type of system.

UEs 1612 may be any of a wide variety of communication devices, including wireless devices arranged, configured, and/or operable to communicate wirelessly with network nodes 1610 and other communication devices. Similarly, network nodes 1610 are arranged, capable, configured, and/or operable to communicate directly or indirectly with UEs 1612 and/or with other network nodes or equipment in telecommunication network 1602 to enable and/or provide network access, such as wireless network access, and/or to perform other functions, such as administration in telecommunication network 1602.

In the depicted example, core network 1606 connects network nodes 1610 to one or more hosts, such as host 1616. These connections may be direct or indirect via one or more intermediary networks or devices. In other examples, network nodes may be directly coupled to hosts. Core network 1606 includes one or more core network nodes (e.g., 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1616 may be under the ownership or control of a service provider other than an operator or provider of access network 1604 and/or telecommunication network 1602, and may be operated by the service provider or on behalf of the service provider. Host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1602 is a cellular network that implements 3GPP standardized features. Accordingly, telecommunication network 1602 may support network slicing to provide different logical networks to different devices that are connected to telecommunication network 1602. For example, telecommunication network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1612 are configured to transmit and/or receive information without direct human interaction. For instance, a UE may be designed to transmit information to access network 1604 on a predetermined schedule, when triggered by an internal or external event, or in response to requests from access network 1604. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1614 communicates with access network 1604 to facilitate indirect communication between one or more UEs (e.g., UE 1612c and/or 1612d) and network nodes (e.g., network node 1610b). In some examples, hub 1614 may be a controller, router, content source and analytics, or any of the other communication devices described herein regarding UEs. For example, hub 1614 may be a broadband router enabling access to core network 1606 for the UEs. As another example, hub 1614 may be a controller that sends commands or instructions to one or more actuators in the UEs. Commands or instructions may be received from the UEs, network nodes 1610, or by executable code, script, process, or other instructions in hub 1614. As another example, hub 1614 may be a data collector that acts as temporary storage for UE data and, in some embodiments, may perform analysis or other processing of the data. As another example, hub 1614 may be a content source. For example, for a UE that is a VR headset, display, loudspeaker or other media delivery device, hub 1614 may retrieve VR assets, video, audio, or other media or data related to sensory information via a network node, which hub 1614 then provides to the UE either directly, after performing local processing, and/or after adding additional local content. In still another example, hub 1614 acts as a proxy server or orchestrator for the UEs, in particular in if one or more of the UEs are low energy IoT devices.

Hub 1614 may have a constant/persistent or intermittent connection to the network node 1610b. Hub 1614 may also allow for a different communication scheme and/or schedule between hub 1614 and UEs (e.g., UE 1612c and/or 1612d), and between hub 1614 and core network 1606. In other examples, hub 1614 is connected to core network 1606 and/or one or more UEs via a wired connection. Moreover, hub 1614 may be configured to connect to an M2M service provider over access network 1604 and/or to another UE over a direct connection. In some scenarios, UEs may establish a wireless connection with network nodes 1610 while still connected via hub 1614 via a wired or wireless connection. In some embodiments, hub 1614 may be a dedicated hub-that is, a hub whose primary function is to route communications to/from the UEs from/to the network node 1610b. In other embodiments, hub 1614 may be a non-dedicated hub—that is, a device which is capable of operating to route communications between the UEs and network node 1610b, but which is additionally capable of operating as a communication start and/or end point for certain data channels.

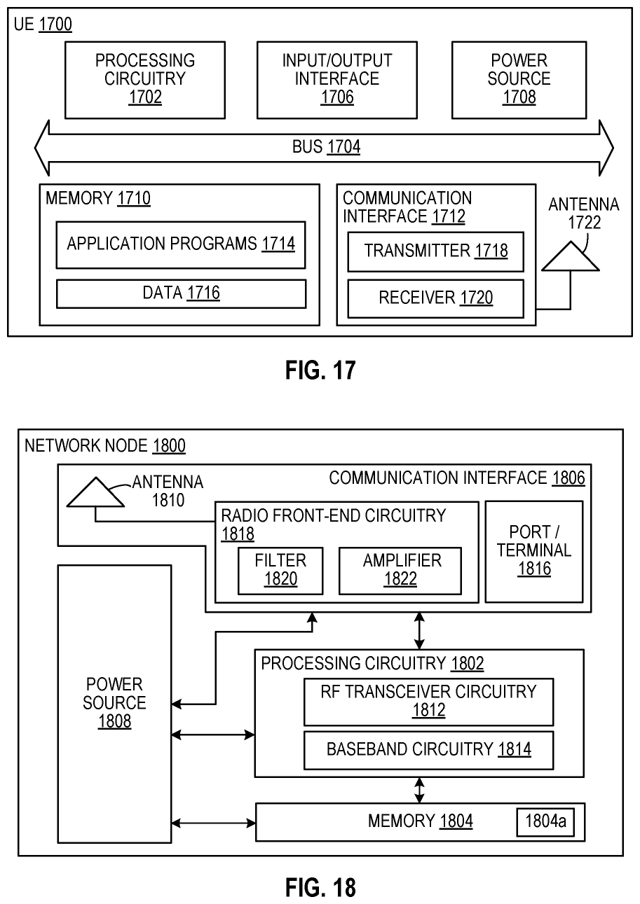

FIG. 17 shows a UE 1700 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1700 includes processing circuitry 1702 that is operatively coupled via a bus 1704 to an input/output interface 1706, a power source 1708, a memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

Processing circuitry 1702 is configured to process instructions and data and may be configured to implement any sequential state machine operative to execute instructions stored as machine-readable computer programs in memory 1710. Processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1702 may include multiple central processing units (CPUs).

In the example, input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1708 is structured as a battery or battery pack. Other types of power sources, such as an external power source (e.g., an electricity outlet), photovoltaic device, or power cell, may be used. Power source 1708 may further include power circuitry for delivering power from power source 1708 itself, and/or an external power source, to the various parts of UE 1700 via input circuitry or an interface such as an electrical power cable. Delivering power may be, for example, for charging of power source 1708. Power circuitry may perform any formatting, converting, or other modification to the power from power source 1708 to make the power suitable for the respective components of UE 1700 to which power is supplied.

Memory 1710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1710 includes one or more application programs 1714, such as an operating system, web browser application, a widget, gadget engine, or other application, and corresponding data 1716. Memory 1710 may store, for use by UE 1700, any of a variety of various operating systems or combinations of operating systems.

Memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1710 may allow UE 1700 to access instructions, application programs and the like, stored on transitory or non-transitory memory media, to off-load data, or to upload data. An article of manufacture, such as one utilizing a communication system may be tangibly embodied as or in memory 1710, which may be or comprise a device-readable storage medium.

Processing circuitry 1702 may be configured to communicate with an access network or other network using communication interface 1712. Communication interface 1712 may comprise one or more communication subsystems and may include or be communicatively coupled to an antenna 1722. Communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, transmitter 1718 and receiver 1720 may be coupled to one or more antennas (e.g., antenna 1722) and may share circuit components, software or firmware, or alternatively be implemented separately.

In the illustrated embodiment, communication functions of communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1700 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 18 shows a network node 1800 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1800 includes processing circuitry 1802, a memory 1804, a communication interface 1806, and a power source 1808. Network node 1800 may be composed of multiple physically separate components (e.g., a NodeB component and a RNC component, or a BTS component and a BSC component, etc.), which may each have their own respective components. In certain scenarios in which network node 1800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). Network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

Processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as memory 1804, to provide network node 1800 functionality.

In some embodiments, processing circuitry 1802 includes a system on a chip (SOC). In some embodiments, processing circuitry 1802 includes one or more of radio frequency (RF) transceiver circuitry 1812 and baseband processing circuitry 1814. In some embodiments, the radio frequency (RF) transceiver circuitry 1812 and the baseband processing circuitry 1814 may be on separate chips (or sets of chips), boards, or units, such as radio units and digital units. In alternative embodiments, part or all of RF transceiver circuitry 1812 and baseband processing circuitry 1814 may be on the same chip or set of chips, boards, or units.

Memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1802. Memory 1804 may store any suitable instructions, data, or information, including a computer program, software, an application including one or more of logic, rules, code, tables, and/or other instructions (collectively denoted computer program product 1804a) capable of being executed by processing circuitry 1802 and utilized by network node 1800. Memory 1804 may be used to store any calculations made by processing circuitry 1802 and/or any data received via communication interface 1806. In some embodiments, processing circuitry 1802 and memory 1804 is integrated.

Communication interface 1806 is used in wired or wireless communication of signaling and/or data between a network node, access network, and/or UE. As illustrated, communication interface 1806 comprises port(s)/terminal(s) 1816 to send and receive data, for example to and from a network over a wired connection. Communication interface 1806 also includes radio front-end circuitry 1818 that may be coupled to, or in certain embodiments a part of, antenna 1810. Radio front-end circuitry 1818 comprises filters 1820 and amplifiers 1822. Radio front-end circuitry 1818 may be connected to an antenna 1810 and processing circuitry 1802. The radio front-end circuitry may be configured to condition signals communicated between antenna 1810 and processing circuitry 1802. Radio front-end circuitry 1818 may receive digital data that is to be sent out to other network nodes or UEs via a wireless connection. Radio front-end circuitry 1818 may convert the digital data into a radio signal having the appropriate channel and bandwidth parameters using a combination of filters 1820 and/or amplifiers 1822. The radio signal may then be transmitted via antenna 1810. Similarly, when receiving data, antenna 1810 may collect radio signals which are then converted into digital data by radio front-end circuitry 1818. The digital data may be passed to processing circuitry 1802. In other embodiments, the communication interface may comprise different components and/or different combinations of components.

In certain alternative embodiments, network node 1800 does not include separate radio front-end circuitry 1818, instead, processing circuitry 1802 includes radio front-end circuitry and is connected to antenna 1810. Similarly, in some embodiments, all or some of RF transceiver circuitry 1812 is part of communication interface 1806. In still other embodiments, communication interface 1806 includes one or more ports or terminals 1816, radio front-end circuitry 1818, and RF transceiver circuitry 1812, as part of a radio unit (not shown), and communication interface 1806 communicates with baseband processing circuitry 1814, which is part of a digital unit (not shown).

Antenna 1810 may include one or more antennas, or antenna arrays, configured to send and/or receive wireless signals. Antenna 1810 may be coupled to radio front-end circuitry 1818 and may be any type of antenna capable of transmitting and receiving data and/or signals wirelessly. In certain embodiments, antenna 1810 is separate from network node 1800 and connectable to network node 1800 through an interface or port.

Antenna 1810, communication interface 1806, and/or processing circuitry 1802 may be configured to perform any receiving operations and/or certain obtaining operations described herein as being performed by the network node. Any information, data and/or signals may be received from a UE, another network node and/or any other network equipment. Similarly, antenna 1810, communication interface 1806, and/or processing circuitry 1802 may be configured to perform any transmitting operations described herein as being performed by the network node. Any information, data and/or signals may be transmitted to a UE, another network node and/or any other network equipment.

Power source 1808 provides power to the various components of network node 1800 in a form suitable for the respective components (e.g., at a voltage and current level needed for each respective component). Power source 1808 may further comprise, or be coupled to, power management circuitry to supply the components of network node 1800 with power for performing the functionality described herein. For example, network node 1800 may be connectable to an external power source (e.g., the power grid, an electricity outlet) via an input circuitry or interface such as an electrical cable, whereby the external power source supplies power to power circuitry of power source 1808. As a further example, power source 1808 may comprise a source of power in the form of a battery or battery pack which is connected to, or integrated in, power circuitry. The battery may provide backup power should the external power source fail.

Embodiments of network node 1800 may include additional components beyond those shown in FIG. 18 for providing certain aspects of the network node's functionality, including any of the functionality described herein and/or any functionality necessary to support the subject matter described herein. For example, network node 1800 may include user interface equipment to allow input of information into network node 1800 and to allow output of information from network node 1800. This may allow a user to perform diagnostic, maintenance, repair, and other administrative functions for network node 1800.

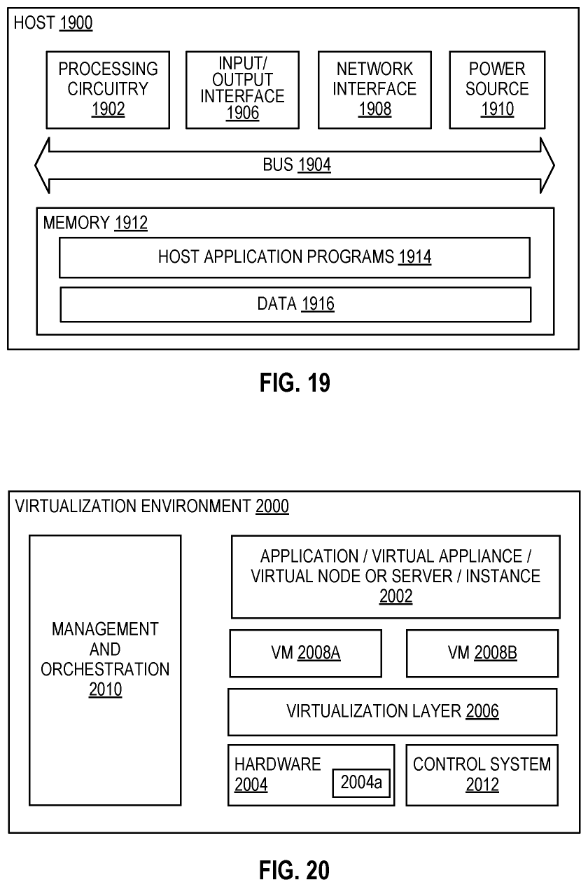

FIG. 19 is a block diagram of a host 1900, which may be an embodiment of host 1616 of FIG. 16, in accordance with various aspects described herein. As used herein, host 1900 may be or comprise various combinations hardware and/or software, including a standalone server, a blade server, a cloud-implemented server, a distributed server, a virtual machine, container, or processing resources in a server farm. Host 1900 may provide one or more services to one or more UEs.

Host 1900 includes processing circuitry 1902 that is operatively coupled via a bus 1904 to an input/output interface 1906, a network interface 1908, a power source 1910, and a memory 1912. Other components may be included in other embodiments. Features of these components may be substantially similar to those described with respect to the devices of previous figures, such as FIGS. 17 and 18, such that the descriptions thereof are generally applicable to the corresponding components of host 1900.

Memory 1912 may include one or more computer programs including one or more host application programs 1914 and data 1916, which may include user data, e.g., data generated by a UE for host 1900 or data generated by host 1900 for a UE. Embodiments of host 1900 may utilize only a subset or all of the components shown. Host application programs 1914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1914 may also provide for user authentication and licensing checks and may periodically report health, routes, and content availability to a central node, such as a device in or on the edge of a core network. Accordingly, host 1900 may select and/or indicate a different host for over-the-top services for a UE. Host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment 1900 to implement some of the features, functions, and/or benefits of some of the embodiments disclosed herein.

Hardware 2004 includes processing circuitry, memory that stores software and/or instructions (collectively denoted computer program product 2004a) executable by hardware processing circuitry, and/or other hardware devices as described herein, such as a network interface, input/output interface, and so forth. Software may be executed by the processing circuitry to instantiate one or more virtualization layers 2006 (also referred to as hypervisors or virtual machine monitors (VMMs)), provide VMs 2008a-b (one or more of which may be generally referred to as VMs 2008), and/or perform any of the functions, features and/or benefits described in relation with some embodiments described herein. Virtualization layer 2006 may present a virtual operating platform that appears like networking hardware to VMs 2008.

VMs 2008 comprise virtual processing, virtual memory, virtual networking or interface and virtual storage, and may be run by a corresponding virtualization layer 2006. Different embodiments of the instance of a virtual appliance 2002 may be implemented on one or more of VMs 2008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, VM 2008 may be a software implementation of a physical machine that runs programs as if they were executing on a physical, non-virtualized machine. Each of VMs 2008, and that part of hardware 2004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2008 on top of the hardware 2004 and corresponds to the application 2002.

Hardware 2004 may be implemented in a standalone network node with generic or specific components. Hardware 2004 may implement some functions via virtualization. Alternatively, hardware 2004 may be part of a larger cluster of hardware (e.g., such as in a data center or CPE) where many hardware nodes work together and are managed via management and orchestration 2010, which, among others, oversees lifecycle management of applications 2002. In some embodiments, hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2012 which may alternatively be used for communication between hardware nodes and radio units.

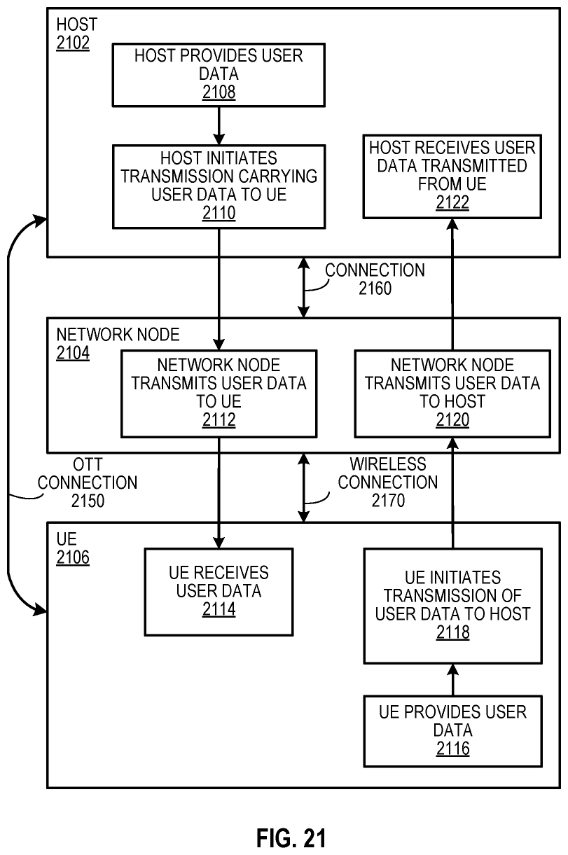

FIG. 21 shows a communication diagram of a host 2102 communicating via a network node 2104 with a UE 2106 over a partially wireless connection in accordance with some embodiments. Example implementations, in accordance with various embodiments, of the UE (such as a UE 1612a of FIG. 16 and/or UE 1700 of FIG. 17), network node (such as network node 1610a of FIG. 16 and/or network node 1800 of FIG. 18), and host (such as host 1616 of FIG. 16 and/or host 1900 of FIG. 19) discussed in the preceding paragraphs will now be described with reference to FIG. 21.

Like host 1900, embodiments of host 2102 include hardware, such as a communication interface, processing circuitry, and memory. Host 2102 also includes software, which is stored in or accessible by host 2102 and executable by the processing circuitry. The software includes a host application that may be operable to provide a service to a remote user, such as UE 2106 connecting via an over-the-top (OTT) connection 2150 extending between UE 2106 and host 2102. In providing the service to the remote user, a host application may provide user data which is transmitted using OTT connection 2150.

Network node 2104 includes hardware enabling it to communicate with host 2102 and UE 2106. Connection 2160 may be direct or pass through a core network (like core network 1606 of FIG. 16) and/or one or more other intermediate networks, such as one or more public, private, or hosted networks. For example, an intermediate network may be a backbone network or the Internet.

UE 2106 includes hardware and software, which is stored in or accessible by UE 2106 and executable by the UE's processing circuitry. The software includes a client application, such as a web browser or operator-specific “app” that may be operable to provide a service to a human or non-human user via UE 2106 with the support of host 2102. In host 2102, an executing host application may communicate with the executing client application via OTT connection 2150 terminating at UE 2106 and host 2102. In providing the service to the user, the UE's client application may receive request data from the host's host application and provide user data in response to the request data. OTT connection 2150 may transfer both the request data and the user data. The UE's client application may interact with the user to generate the user data that it provides to the host application through OTT connection 2150.

OTT connection 2150 may extend via a connection 2160 between host 2102 and network node 2104 and via a wireless connection 2170 between network node 2104 and UE 2106 to provide the connection between host 2102 and UE 2106. Connection 2160 and wireless connection 2170, over which OTT connection 2150 may be provided, have been drawn abstractly to illustrate the communication between host 2102 and UE 2106 via network node 2104, without explicit reference to any intermediary devices and the precise routing of messages via these devices.

As an example of transmitting data via OTT connection 2150, in step 2108, host 2102 provides user data, which may be performed by executing a host application. In some embodiments, the user data is associated with a particular human user interacting with UE 2106. In other embodiments, the user data is associated with a UE 2106 that shares data with host 2102 without explicit human interaction. In step 2110, host 2102 initiates a transmission carrying the user data towards UE 2106. Host 2102 may initiate the transmission responsive to a request transmitted by UE 2106. The request may be caused by human interaction with UE 2106 or by operation of the client application executing on UE 2106. The transmission may pass via network node 2104, in accordance with the teachings of the embodiments described throughout this disclosure. Accordingly, in step 2112, network node 2104 transmits to UE 2106 the user data that was carried in the transmission that host 2102 initiated, in accordance with the teachings of the embodiments described throughout this disclosure. In step 2114, UE 2106 receives the user data carried in the transmission, which may be performed by a client application executed on UE 2106 associated with the host application executed by host 2102.

In some examples, UE 2106 executes a client application which provides user data to host 2102. The user data may be provided in reaction or response to the data received from host 2102. Accordingly, in step 2116, UE 2106 may provide user data, which may be performed by executing the client application. In providing the user data, the client application may further consider user input received from the user via an input/output interface of UE 2106. Regardless of the specific manner in which the user data was provided, UE 2106 initiates, in step 2118, transmission of the user data towards host 2102 via network node 2104. In step 2120, in accordance with the teachings of the embodiments described throughout this disclosure, network node 2104 receives user data from UE 2106 and initiates transmission of the received user data towards host 2102. In step 2122, host 2102 receives the user data carried in the transmission initiated by UE 2106.

One or more of the various embodiments improve the performance of OTT services provided to UE 2106 using OTT connection 2150, in which the wireless connection 2170 forms the last segment. More precisely, embodiments provide flexible and efficient techniques for coordination between first and second NNFs in a RAN, so that RVQoE measurements can be distributed or transferred in a controlled manner. In this manner, embodiments avoid excess signaling of unwanted and/or unusable RVQoE measurements. Moreover, distribution of RVQOE measurements facilitate RAN operations such as QoE-aware traffic steering, scheduling and link adaptation, mobility-related decisions, mobility decision evaluation, and inputs to AI/ML algorithms used for network optimization and/or fault prediction. By distributing RVQoE measurements that facilitate such operations, embodiments can lead to improved RAN performance as experienced by applications, including OTT services. These improvements increase the value of such OTT services to end users and service providers.

In an example scenario, factory status information may be collected and analyzed by host 2102. As another example, host 2102 may process audio and video data which may have been retrieved from a UE for use in creating maps. As another example, host 2102 may collect and analyze real-time data to assist in controlling vehicle congestion (e.g., controlling traffic lights). As another example, host 2102 may store surveillance video uploaded by a UE. As another example, host 2102 may store or control access to media content such as video, audio, VR or AR which it can broadcast, multicast or unicast to UEs. As other examples, host 2102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring OTT connection 2150 between host 2102 and UE 2106, in response to variations in the measurement results. The measurement procedure and/or the network functionality for reconfiguring the OTT connection may be implemented in software and hardware of host 2102 and/or UE 2106. In some embodiments, sensors (not shown) may be deployed in or in association with other devices through which OTT connection 2150 passes; the sensors may participate in the measurement procedure by supplying values of the monitored quantities exemplified above, or supplying values of other physical quantities from which software may compute or estimate the monitored quantities. Reconfiguring of OTT connection 2150 may include message format, retransmission settings, preferred routing etc.; the reconfiguring need not directly alter the operation of network node 2104. Such procedures and functionalities may be known and practiced in the art. In certain embodiments, measurements may involve proprietary UE signaling that facilitates measurements of throughput, propagation times, latency and the like, by host 2102. The measurements may be implemented in that software causes messages to be transmitted, in particular empty or ‘dummy’ messages, using OTT connection 2150 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:
A1. A method for a first network node or function (NNF) of a radio access network (RAN) to manage distribution within the RAN of quality-of-experience (QoE) measurements by user equipment (UEs), the method comprising:
   receiving one or more fourth messages from a second NNF of the RAN, wherein:
      each fourth message includes one or more RAN-visible QoE (RVQoE) measurement reports, and
      each RVQoE measurement report includes one or more RVQoE metrics or values, each based on QoE measurements performed by a particular UE that is associated with the first NNF.
A2. The method of embodiment A1, further comprising, based on the one or more fourth messages, performing one or more of the following for one or more the UEs that performed QoE measurements associated with the RVQoE measurement reports: scheduling data transmission and/or reception, and selection of a modulation and coding scheme for data transmission and/or reception.
A3. The method of any of embodiments A1-A2, further comprising sending, to the second NNF, a first message including a request for RVQoE measurement reports, wherein the fourth message is received in response to the first message.
A4. The method of any of embodiments A1-A2, further comprising:
   receiving, from the second NNF, a second message including an offer to send RVQoE measurement reports to the first NNF; and
   sending, to the second NNF, a ninth message including an indication of whether the first NNF accepts or rejects the offer,
   wherein the one or more fourth messages are received in response to the ninth message indicating that the first NNF accepts the offer.
A4a. The method of any of embodiments A3-A4, wherein each first message, second message, and fourth message include identifiers of one or more of the following: UE, UE group, QoE reference, trace recording session, and application layer measurement configuration.
A4b. The method of any of embodiments A3-A4, wherein the first message or the second message indicates RVQoE measurements from all UEs that are configured for RVQoE measurements and associated with or served by one of the following: the first NNF, or the second NNF.
A4c. The method of any of embodiments A3-A4b, wherein the first message or the second message indicates RVQoE measurements associated with one or more of the following: network slice, cell, beam, data radio bearer, communication direction between a UE and an NNF, communication path through the RAN, protocol type, protocol addresses and/or port numbers, and a reporting periodicity.
A4d. The method of any of embodiments A3-A4c, wherein the first message or the second message indicates one or more of the following:
   one-shot or periodic reporting;
   if periodic, a period of the reports;
   if one-shot, a time interval to which a report pertains or which should be excluded from a report;
   a number of RVQoE measurements per fourth message;
   one or more UE-related triggering events or conditions;
   one or more RVQoE-related triggering events or conditions;
   one or more RRC- or radio-related triggering events or conditions:
   one or more UE application layer triggering events or conditions; and
   one or more NNF resource-related triggering events or conditions.
A5. The method of any of embodiments A1-A4d, further comprising:
   receiving, from the second NNF, a third message including a request for feedback associated with RVQoE measurement reports sent by the second NNF; and
   sending, to the second NNF in response to the third message, one or more sixth messages comprising feedback associated with RVQoE measurement reports received in the one or more fourth messages.
A6. The method of embodiment A5, wherein each sixth message is associated with a corresponding fourth message and includes indication of one or more of the following:
   whether the one or more RVQOE metrics or values in the associated fourth message were used by the first NNF;
   one or more operations performed by the first NNF based on the one or more RVQoE metrics or values in the associated fourth message; and
   one or more effects on UEs of operations performed by the first NNF based on the one or more RVQoE metrics or values in the associated fourth message.
A7. The method of any of embodiments A5-A6, further comprising receiving, from the second NNF, a fifth message including assistance information for RVQoE measurement reports provided by or available from the second NNF.
A8. The method of embodiment A7, wherein one or more of the following applies:
   the feedback included in the one or more sixth messages is based on the assistance information; and
   the assistance information includes identifiers of one or more of the following associated with RVQoE measurement reports received in the one or more fourth messages: UE, UE group, QoE reference, trace recording session, application session PDU session, application layer measurement configuration, network slice, cell, beam, data radio bearer, communication direction, protocol type, and protocol addresses and/or port numbers.
A8a. The method of any of embodiments A5-A8, wherein one of the third message, fourth message, and fifth message is received with at least one other of the third message, fourth message, and fifth message in a single message.
A9. The method of any of embodiments A1-A8a, further comprising receiving, from a third NNF, a seventh message including an indication to enable receiving of RVQoE measurement reports, wherein the one or more fourth messages are received responsive to the seventh message.
A10. The method of embodiment A9, further comprising:
   after receiving the one or more fourth messages, receiving from the third NNF a further seventh message including an indication to disable receiving of RVQoE measurement reports; and
   refraining from receiving further fourth messages from the second NNF based on the further seventh message.
A11. The method of any of embodiments A1-A10, wherein the first NNF is a gNB-DU and the second NNF is a gNB-CU or a part thereof, and the first message is sent via an F1AP interface between the first and second NNFs.
A12. The method of any of embodiments A1-A10, wherein the first NNF is a first RAN node and the second NNF is a second RAN node, and the first message is sent via an XnAP interface between the first and second NNFs.
B1. A method for a second network node or function (NNF) of a radio access network (RAN) to manage distribution in the RAN of quality-of-experience (QoE) measurements by user equipment (UEs), the method comprising:
   sending one or more fourth messages to a first NNF of the RAN, wherein:
      each fourth message includes one or more RAN-visible QoE (RVQoE) measurement reports, and
      each RVQoE measurement report includes one or more RVQoE metrics or values, each based on QoE measurements performed by a particular UE that is associated with the first NNF.
B2. The method of embodiment B1, further comprising sending, to a fourth NNF of the RAN, an indication that the fourth NNF should send further fourth messages to the first NNF.
B2a. The method of embodiment B2, further comprising:
   receiving, from the fourth NNF, aa RVQoE measurement reporting configuration for further fourth messages to be sent to the first NNF; and
   sending the RVQoE measurement reporting configuration to the first NNF.
B2b. The method of any of embodiments B2-B2a, wherein sending the indication to the fourth NNF is responsive to initiating a handover of the first NNF from the second NNF to the fourth NNF.
B3. The method of any of embodiments B1-B2b, further comprising receiving, from the second NNF, a first message including a request for RVQoE measurement reports, wherein the one or more fourth messages are sent in response to the first message.
B4. The method of any of embodiments B1-B2, further comprising:
   sending, to the first NNF, a second message including an offer to send RVQoE measurement reports to the first NNF; and
   receiving, from the first NNF, a ninth message including an indication of whether the first NNF accepts or rejects the offer,
   wherein the one or more fourth messages are sent in response to the ninth message indicating that the first NNF accepts the offer.
B4a. The method of any of embodiments B3-B4, wherein each first message, second message, and fourth message include identifiers of one or more of the following: UE, UE group, QoE reference, trace recording session, and application layer measurement configuration.
B4b. The method of any of embodiments B3-B4, wherein the first message or the second message indicates RVQoE measurements from all UEs that are configured for RVQoE measurements and associated with or served by one of the following: the first NNF, or the second NNF.
B4c. The method of any of embodiments B3-B4b, wherein the first message or the second message indicates RVQoE measurements associated with one or more of the following: network slice, cell, beam, data radio bearer, communication direction between a UE and an NNF, communication path through the RAN, protocol type, protocol addresses and/or port numbers, and a reporting periodicity.
B4d. The method of any of embodiments B3-B4c, wherein the first message or the second message indicates one or more of the following:
   one-shot or periodic reporting;
   if periodic, a period of the reports;
   if one-shot, a time interval to which a report pertains or which should be excluded from a report;
   a number of RVQoE measurements per fourth message;
   one or more UE-related triggering events or conditions;
   one or more RVQoE-related triggering events or conditions;
   one or more RRC- or radio-related triggering events or conditions:
   one or more UE application layer triggering events or conditions
   one or more NNF resource-related triggering events or conditions
B5. The method of any of embodiments B1-B4d, further comprising:
   sending, to the first NNF, a third message including a request for feedback associated with RVQoE measurement reports sent by the second NNF; and
   receiving, from the first NNF in response to the third message, one or more sixth messages comprising feedback associated with RVQoE measurement reports received in the one or more fourth messages.
B6. The method of embodiment B5, wherein each sixth message is associated with a corresponding fourth message and includes indication of one or more of the following:
   whether the one or more RVQOE metrics or values in the associated fourth message were used by the first NNF;
   one or more operations performed by the first NNF based on the one or more RVQoE metrics or values in the associated fourth message; and
   one or more effects on UEs of operations performed by the first NNF based on the one or more RVQoE metrics or values in the associated fourth message.
B7. The method of any of embodiments A5-A6, further comprising sending, to the first NNF, a fifth message including assistance information for RVQoE measurement reports provided by or available from the second NNF.
B8. The method of embodiment B7, wherein one or more of the following applies:
   the feedback included in the one or more sixth messages is based on the assistance information; and
   the assistance information includes identifiers of one or more of the following associated with RVQoE measurement reports received in the one or more fourth messages: UE, UE group, QoE reference, trace recording session, application session PDU session, application layer measurement configuration, network slice, cell, beam, data radio bearer, communication direction, protocol type, and protocol addresses and/or port numbers.
B8a. The method of any of embodiments B5-B8, wherein one of the third message, fourth message, and fifth message is received with at least one other of the third message, fourth message, and fifth message in a single message.
B9. The method of any of embodiments B1-B8a, further comprising receiving, from a third NNF, a seventh message including an indication to enable sending of RVQoE measurement reports, wherein the one or more fourth messages are sent responsive to the seventh message.
B10. The method of embodiment B9, further comprising:
   after sending the one or more fourth messages, receiving from the third NNF a further seventh message including an indication to disable sending of RVQoE measurement reports; and
   refraining from sending further fourth messages to the first NNF based on further seventh message.
B11. The method of any of embodiments B1-B10, wherein the first NNF is a gNB-DU and the second NNF is a gNB-CU or a part thereof, and the first message is sent via an F1AP interface between the first and second NNFs.
B12. The method of any of embodiments B1-B10, wherein the first NNF is a first RAN node and the second NNF is a second RAN node, and the first message is sent via an XnAP interface between the first and second NNFs.
C1. A method for a fourth network node or function (NNF) of a radio access network (RAN) to manage distribution in the RAN of quality-of-experience (QoE) measurements by user equipment (UEs), the method comprising:
   receiving, from a second NNF of the RAN, an indication that the fourth NNF should send further fourth messages to a first NNF of the RAN, wherein:
      the second NNF is currently configured to send fourth messages to the first NNF,
      each fourth message includes one or more RAN-visible QoE (RVQoE) measurement reports, and
      each RVQoE measurement report includes one or more RVQoE metrics or values, each based on QoE measurements performed by a UE that is currently associated with the first NNF.
C2. The method of embodiment C1, further comprising:
   determining an RVQoE measurement reporting configuration for the further fourth messages; and
   sending the RVQoE measurement reporting configuration to the second NNF.
C3. The method of any of embodiments C1-C2, wherein the indication is received from the second NNF in conjunction with a handover of the first NNF from the second NNF to the fourth NNF.
C4. The method of embodiment C3, further comprising sending one or more further fourth messages to the first NNF after completion of the handover.
C5. The method of any of embodiments C1-C4, wherein the first NNF is an integrated access backhaul (IAB) node comprising a mobile termination (MT) portion and a distributed unit (DU) portion.
D1. A first network node or function (NNF) of a radio access network (RAN), the first NNF being configured to manage distribution within the RAN of quality-of-experience (QoE) measurements by user equipment (UEs), the first NNF comprising:
   communication interface circuitry configured to communicate with UEs and with one or more other NNFs of the RAN; and
   processing circuitry operatively coupled to the communication interface circuitry, whereby the processing circuitry and the communication interface circuitry are configured to perform operations corresponding to any of the methods of embodiments A1-A12.
D2. A first network node or function (NNF) of a radio access network (RAN), the first NNF being configured to manage distribution within the RAN of quality-of-experience (QoE) measurements by user equipment (UEs), the first NNF being further configured to perform operations corresponding to any of the methods of embodiments A1-A12.
D3. A non-transitory, computer-readable medium storing computer-executable instructions that, when executed by processing circuitry of a first network node or function (NNF) configured to manage distribution within a radio access network (RAN) of quality-of-experience (QoE) measurements by user equipment (UEs), configure the first NNF to perform operations corresponding to any of the methods of embodiments A1-A12.
D4. A computer program product comprising computer-executable instructions that, when executed by processing circuitry of a first network node or function (NNF) configured to manage distribution within a radio access network (RAN) of quality-of-experience (QoE) measurements by user equipment (UEs), configure the first NNF to perform operations corresponding to any of the methods of embodiments A1-A12.
E1. A second network node or function (NNF) of a radio access network (RAN), the second NNF being configured to manage distribution within the RAN of quality-of-experience (QoE) measurements by user equipment (UEs), the second NNF comprising:
   communication interface circuitry configured to communicate with UEs and with one or more other NNFs of the RAN; and
   processing circuitry operatively coupled to the communication interface circuitry, whereby the processing circuitry and the communication interface circuitry are configured to perform operations corresponding to any of the methods of embodiments B1-B12.
E2. A second network node or function (NNF) of a radio access network (RAN), the second NNF being configured to manage distribution within the RAN of quality-of-experience (QoE) measurements by user equipment (UEs), the second NNF being further configured to perform operations corresponding to any of the methods of embodiments B1-B12.
E3. A non-transitory, computer-readable medium storing computer-executable instructions that, when executed by processing circuitry of a second network node or function (NNF) configured to manage distribution within a radio access network (RAN) of quality-of-experience (QoE) measurements by user equipment (UEs), configure the second NNF to perform operations corresponding to any of the methods of embodiments B1-B12.
E4. A computer program product comprising computer-executable instructions that, when executed by processing circuitry of a second network node or function (NNF) configured to manage distribution within a radio access network (RAN) of quality-of-experience (QoE) measurements by user equipment (UEs), configure the second NNF to perform operations corresponding to any of the methods of embodiments B1-B12.
F1. A fourth network node or function (NNF) of a radio access network (RAN), the fourth NNF being configured to manage distribution within the RAN of quality-of-experience (QoE) measurements by user equipment (UEs), the fourth NNF comprising:
   communication interface circuitry configured to communicate with UEs and with one or more other NNFs of the RAN; and
   processing circuitry operatively coupled to the communication interface circuitry, whereby the processing circuitry and the communication interface circuitry are configured to perform operations corresponding to any of the methods of embodiments C1-C5.
F2. A fourth network node or function (NNF) of a radio access network (RAN), the fourth NNF being configured to manage distribution within the RAN of quality-of-experience (QoE) measurements by user equipment (UEs), the fourth NNF being further configured to perform operations corresponding to any of the methods of embodiments C1-C5.
F3. A non-transitory, computer-readable medium storing computer-executable instructions that, when executed by processing circuitry of a fourth network node or function (NNF) configured to manage distribution within a radio access network (RAN) of quality-of-experience (QoE) measurements by user equipment (UEs), configure the fourth NNF to perform operations corresponding to any of the methods of embodiments C1-C5.
F4. A computer program product comprising computer-executable instructions that, when executed by processing circuitry of a fourth network node or function (NNF) configured to manage distribution within a radio access network (RAN) of quality-of-experience (QoE) measurements by user equipment (UEs), configure the fourth NNF to perform operations corresponding to any of the methods of embodiments C1-C5.

1.-38. (canceled)

39. A method for distributing quality-of-experience (QoE) measurements performed by user equipment (UEs) in a radio access network (RAN), the method performed by a first network node or function (NNF) of the RAN and comprising:
receiving one or more fourth messages from a second NNF of the RAN, wherein:
each fourth message includes one or more RAN-visible QoE (RVQoE) measurement reports,
each RVQoE measurement report includes one or more RVQoE metrics or values, and
each RVQoE metric or value is based on QoE measurements performed by a particular UE that is associated with the first NNF; and
sending, to the second NNF, a first message including a request to stop sending RVQoE measurement reports to the first NNF.

40. The method of claim 39, further comprising, based on the one or more fourth messages, performing one or more of the following for one or more the UEs that performed QoE measurements associated with the RVQoE measurement reports: scheduling data transmission and/or reception, and selection of a modulation and coding scheme for data transmission and/or reception.

41. The method of claim 39, further comprising sending, to the second NNF, a further first message including a request to start sending RVQoE measurement reports to the first NNF, wherein the one or more fourth messages are received in response to the further first message.

42. The method of claim 41, wherein the further first message indicates one or more of the following:
one-shot or periodic reporting;
when periodic reporting is indicated, a reporting period;
when one-shot reporting is indicated, a time interval to which a report pertains or which should be excluded from a report;
a total number or amount of RVQoE measurements;
a number of RVQoE measurements per fourth message;
one or more UE-related triggering events or conditions;
one or more RVQoE-related triggering events or conditions;
one or more RRC- or radio-related triggering events or conditions:
one or more UE application layer triggering events or conditions; and
one or more NNF resource-related triggering events or conditions.

43. The method of claim 41, wherein the further first message indicates RVQoE measurements from all UEs that are configured for RVQoE measurements and associated with or served by one of the following: the first NNF, or the second NNF.

44. The method of claim 41, wherein the further first message indicates RVQoE measurements associated with one or more of the following: network slice, cell, beam, data radio bearer, communication direction between a UE and an NNF, communication path through the RAN, protocol type, protocol addresses and/or port numbers, and a reporting periodicity.

45. The method of claim 41, wherein the first message and the further first message include same identifiers of one or more of the following: UE, UE group, QoE reference, trace recording session, and application layer measurement configuration.

46. The method of claim 39, further comprising:
receiving, from the second NNF, a second message including an offer to send RVQoE measurement reports to the first NNF; and
sending, to the second NNF, a ninth message including an indication of whether the first NNF accepts or rejects the offer,
wherein the one or more fourth messages are received in response to the ninth message indicating that the first NNF accepts the offer.

47. The method of claim 39, wherein:
the method further comprises receiving, from the second NNF, a fifth message including assistance information for RVQoE measurement reports provided by or available from the second NNF; and
the assistance information includes identifiers of one or more of the following associated with RVQoE measurement reports received in the one or more fourth messages: UE, UE group, QoE reference, trace recording session, application session, PDU session, application layer measurement configuration, network slice, cell, beam, data radio bearer, communication direction, protocol type, protocol addresses, and protocol port numbers.

48. The method of claim 39, wherein the first NNF is a gNB-DU, the second NNF is a gNB-CU or a part thereof, and the first message is sent via an F1AP interface between the first and second NNFs.

49. A method for distributing quality-of-experience (QoE) measurements performed by user equipment (UEs) in a radio access network (RAN), the method performed by a second network node or function (NNF) of the RAN and comprising:
sending one or more fourth messages to a first NNF of the RAN, wherein:
each fourth message includes one or more RAN-visible QoE (RVQoE) measurement reports,
each RVQoE measurement report includes one or more RVQoE metrics or values, and
each RVQoE metric or value is based on QoE measurements performed by a particular UE that is associated with the first NNF,
receiving, from the first NNF, a first message including a request to stop sending RVQoE measurement reports to the first NNF.

50. The method of claim 49, further comprising based on the first message, refraining from sending the first NNF further fourth messages including RVQoE measurement reports.

51. The method of claim 49, further comprising receiving, from the first NNF, a further first message including a request to start sending RVQoE measurement reports to the first NNF, wherein the one or more fourth messages are sent in response to the further first message.

52. The method of claim 51, wherein the further first message indicates RVQoE measurements from all UEs that are configured for RVQoE measurements and associated with or served by one of the following: the first NNF, or the second NNF.

53. The method of claim 49, further comprising:
sending, to the first NNF, a second message including an offer to send RVQoE measurement reports to the first NNF; and
receiving, from the first NNF, a ninth message including an indication of whether the first NNF accepts or rejects the offer,
wherein the one or more fourth messages are sent in response to the ninth message indicating that the first NNF accepts the offer.

54. The method of claim 49, wherein:
the method further comprises sending, to the first NNF, a fifth message including assistance information for RVQoE measurement reports provided by or available from the second NNF; and
the assistance information includes identifiers of one or more of the following associated with RVQoE measurement reports received in the one or more fourth messages: UE, UE group, QoE reference, trace recording session, application session PDU session, application layer measurement configuration, network slice, cell, beam, data radio bearer, communication direction, protocol type, protocol addresses, and protocol port numbers.

55. A first network node or function (NNF) configured to distribute quality-of-experience (QoE) measurements performed by user equipment (UEs) in a radio access network (RAN), the first NNF comprising:
communication interface circuitry configured to communicate with UEs and with one or more other NNFs of the RAN; and
processing circuitry operatively coupled to the communication interface circuitry, wherein the processing circuitry and the communication interface circuitry are configured to:
receive one or more fourth messages from a second NNF of the RAN, wherein:
each fourth message includes one or more RAN-visible QoE (RVQoE) measurement reports,
each RVQoE measurement report includes one or more RVQoE metrics or values, and
each RVQoE metric or value is based on QoE measurements performed by a particular UE that is associated with the first NNF; and
send, to the second NNF, a first message including a request to stop sending RVQoE measurement reports to the first NNF.

56. The first NNF of claim 55, wherein:
the processing circuitry and the communication interface circuitry are further configured to receive, from the second NNF, a fifth message including assistance information for RVQoE measurement reports provided by or available from the second NNF; and
the assistance information includes identifiers of one or more of the following associated with RVQoE measurement reports received in the one or more fourth messages: UE, UE group, QoE reference, trace recording session, application session, PDU session, application layer measurement configuration, network slice, cell, beam, data radio bearer, communication direction, protocol type, protocol addresses, and protocol port numbers.

57. A second network node or function (NNF) configured to distribute quality-of-experience (QoE) measurements performed by user equipment (UEs) in a radio access network (RAN), the second NNF comprising:
communication interface circuitry configured to communicate with UEs and with one or more other NNFs of the RAN; and
processing circuitry operatively coupled to the communication interface circuitry, wherein the processing circuitry and the communication interface circuitry are configured to:
send one or more fourth messages to a first NNF of the RAN, wherein:
each fourth message includes one or more RAN-visible QoE (RVQoE) measurement reports,
each RVQoE measurement report includes one or more RVQoE metrics or values, and
each RVQoE metric or value is based on QoE measurements performed by a particular UE that is associated with the first NNF,
receive, from the first NNF, a first message including a request to stop sending RVQoE measurement reports to the first NNF.

58. The second NNF of claim 57, wherein:
the processing circuitry and the communication interface circuitry are further configured to send, to the first NNF, a fifth message including assistance information for RVQoE measurement reports provided by or available from the second NNF; and
the assistance information includes identifiers of one or more of the following associated with RVQoE measurement reports received in the one or more fourth messages: UE, UE group, QoE reference, trace recording session, application session PDU session, application layer measurement configuration, network slice, cell, beam, data radio bearer, communication direction, protocol type, protocol addresses, and protocol port numbers.
